(19) United States
(12) Patent Application Publication
(10) Pub. No.: US 2026/0300577 A1
(43) Pub. Date: Oct. 1, 2026

(54) SYSTEMS AND METHODS FOR CONSTRAINING ADDITIVE MANUFACTURING BY USE OF PREDICTIVE MODELING TECHNIQUES

(71) Applicant: Vixiv, Inc., Cincinnati, OH (US)

(72) Inventors: Aaron Chow, Cincinnati, OH (US); Zachary Beller, Atlanta, GA (US); Zhenyu Dai, Cincinnati, OH (US); Frederick Shelton, IV, Hillsboro, OH (US); Michael Bonaventura, Cincinnati, OH (US); Honor Robertson, Cincinnati, OH (US)

(73) Assignee: Vixiv, Inc., Cincinnati, OH (US)

(21) Appl. No.: 19/633,856

(22) Filed: Mar. 30, 2026

Related U.S. Application Data
(60) Provisional application No. 63/780,241, filed on Mar. 29, 2025.

(51) Int. Cl. G06F 30/23; G06F 30/27; G06F 111/04

(52) U.S. Cl. CPC G06F 30/23; G06F 30/27; G06F 2111/04

(57) ABSTRACT

Disclosed is a computer-implemented method for designing three-dimensional structures including performing a finite element analysis on a structure to identify locations experiencing external forces having greater magnitude relative to other locations, and dividing the structure into one or more zones based on the locations of the external forces. Selecting a baseline voxel shape and a cell size for a lattice to fill a one of the zones, wherein the selection includes accounting for an external shell shape adjacent to the zone; using an AI model to calculate an effect of a first physics constraint exerted on the zone; and using a second AI model to calculate an effect of a second physics constraint exerted on the zone. Once selected, the zone is populated with the baseline lattice, and a characteristic of the lattice is iteratively adjusted a range of options to generate a plurality of candidate designs.

### CROSS-REFERENCE TO RELATED APPLICATIONS

This application claims priority from U.S. Provisional Patent Application No. 63/780,241, filed Mar. 29, 2026, and has a specification that builds upon U.S. Patent Application No. 18/816,130, filed Aug. 27, 2024, and U.S. Patent Application No. 18/933,646, filed Oct. 31, 2024, all of which are hereby incorporated by reference herein in their entirety.

### BACKGROUND OF THE INVENTION

### Field of the Invention

Embodiments of the disclosed invention relate to artificial intelligence-assisted engineering and design of tools, parts, assemblies, and components. In particular, the invention includes systems and methods for constraining designs produced through AI modeling through use of predictive modeling techniques.

### Relevant Background

Traditional three-dimensional (3-D) structure design and engineering has been limited by the number of design parameters that can be concurrently considered. For example, a structure may be optimized for high strength with low weight. Other characteristics, however, such as impact resistance or vibrational response properties, must be addressed separately. Such disjointed design processes are inefficient because the effects of structural changes that improve certain performance characteristics could have unknown effects on others. The cascading effects of design changes cannot be assessed until after those changes are made. Traditional methods for multivariate parameter design are frequently burdened by high computational overhead, requiring numerous iterations that often fail to converge on a solution meeting all target performance criteria.

Generalized AI assisted 3-D structural design systems and methods can improve upon traditional design processes because they are capable of generating novel 3-D structures capable of satisfying multiple and potentially competing performance criteria. However, structural designs produced by AI-assisted modeling suffer from various practical challenges that can prevent their translation into useable structures. For example, designs must reflect the limitations imposed by the laws of physics, which are expressed as mathematical constraints imposed on design models. Similarly, geometric limitations, such as the necessity to align internal lattice structures, can prevent the translation of a design into a workable structure. Limitations imposed by manufacturing equipment, such as translation of a design from one 3- D printer, or one material, to another, or the management of defects resulting from the additive manufacturing process, is another category of challenges. No means of constraining AI-assisted structural design according to such considerations is known in the art.

Therefore, it is clear that what is needed are systems and methods that constrain AI-assisted structural design processes so that conceptual designs are suitable for translation into actual structures. Such constraints include physics-based constraints, geometric constraints, and manufacturing constraints. These and many other deficiencies of the prior art are addressed by one or more embodiments of the disclosed invention.

Additional advantages and novel features of this invention shall be set forth in part in the description that follows, and in part will become apparent to those skilled in the art upon examination of the following specification or may be learned by the practice of the invention.

### BRIEF DESCRIPTION OF THE DRAWINGS

Features and objects of the disclosed invention and the manner of attaining them will become more apparent, and the invention itself will be best understood, by reference to the following description of one or more embodiments taken in conjunction with the accompanying drawings attached following this description.

FIG. 1 depicts a flow chart showing an exemplary procedure for building a lattice as used in embodiments of the disclosed invention.

FIGS. 2A and 2B depict an exemplary structure with lattices designed according to embodiments of the disclosed invention.

FIG. 3 depicts an exemplary voxel shape as used in embodiments of the disclosed invention.

FIG. 4 depicts an exemplary voxel shape as used in embodiments of the disclosed invention.

FIGS. 5A and 5B depict flow charts showing exemplary procedures for accounting for physics constraints as used in embodiments of the disclosed invention.

FIG. 6 depicts and exemplary heat gating lattice as used in embodiments of the disclosed invention.

FIG. 7 depicts an exemplary voxel shape as used in embodiments of the disclosed invention.

FIG. 8 depicts an exemplary voxel shape as used in embodiments of the disclosed invention.

FIG. 9 depicts an exemplary voxel shape as used in embodiments of the disclosed invention.

FIG. 10 depicts an exemplary structure with lattices designed according to embodiments of the disclosed invention.

FIG. 11 depicts a flow chart showing an exemplary procedure for defining an external shell of a structure as used in embodiments of the disclosed invention.

FIG. 12 depicts an exemplary procedure for determining overlap zones according to embodiments of the disclosed invention.

FIG. 13 depicts a flow chart showing an exemplary procedure for developing lattice element interfaces as used in embodiments of the disclosed invention.

FIG. 14 depicts an exemplary structure to be designed according to embodiments of the disclosed invention.

FIGS. 15A and 15B depict exemplary structures populated with lattices according to embodiments of the disclosed invention.

FIG. 16 depicts an exemplary mapping scale as used in embodiments of the disclosed invention.

FIG. 17 depicts a flow chart showing an exemplary procedure for orienting structural elements for an external force as used in embodiments of the disclosed invention.

FIG. 18 depicts an exemplary voxel shape as used in embodiments of the disclosed invention.

FIG. 19 depicts an exemplary procedure for designing a new lattice shape as used in embodiments of the disclosed invention.

FIG. 20 depicts an exemplary voxel shape as used in embodiments of the disclosed invention.

FIG. 21 depicts an exemplary voxel shape as used in embodiments of the disclosed invention.

FIG. 22 depicts an exemplary voxel shape as used in embodiments of the disclosed invention.

FIG. 23 depicts an exemplary process for determining overlap zones according to embodiments of the disclosed invention.

FIG. 24 depicts an exemplary process for determining overlap zones according to embodiments of the disclosed invention.

FIG. 25 depicts an exemplary process for determining overlap zones according to embodiments of the disclosed invention.

FIG. 26 depicts an exemplary process for determining overlap zones according to embodiments of the disclosed invention.

FIG. 27 depicts an exemplary graphical user interface according to embodiments of the disclosed invention.

FIG. 28 depicts an exemplary process for rendering a surface mesh according to embodiments of the disclosed invention.

FIG. 29 depicts a flow chart showing an exemplary procedure for designing structures according to embodiments of the disclosed invention.

FIG. 30 depicts a block diagram showing an exemplary specialized computer system as used in embodiments of the disclosed invention.

The Figures depict embodiments of the disclosed invention for purposes of illustration only. One skilled in the art will readily recognize from the following discussion that alternative embodiments of the structures and methods illustrated herein may be employed without departing from the principles of the invention described herein.

### DEFINITIONS

A voxel or cell is a polygon in three-dimensional (3-D) space and is analogous to a pixel in two-dimensional (2-D) space. An arrangement of voxels filled with an internal structure can be used to approximate any 3-D structure. A voxel represents the smallest subdivision of space for a particular application and is not subdivided.

A supervoxel, or Svoxel is a volumetric unit that includes one or more similar voxels. A group of Svoxels can be used to approximate any 3-D structure, but an Svoxel can be subdivided and filled with an internal structure. In addition, Svoxels can be interconnected in different ways, allowing the structure to have different structural properties based on the shape of the external shell and the shell’s interaction with the underlying Svoxel lattice.

Optimization means a non-linear exploratory process by which a structure is adjusted to achieve a configuration that best meets multiple competing performance requirements or physical attribute requirements. Optimization can be achieved in a single step or many, depending on how demanding the requirements are and how effective the optimization technique is. Optimization may require regression to a prior configuration if one path is determined to be less optimal than another.

Finite Element Analysis (FEA) means the simulation of the behavior of a part or assembly under given physical conditions to allow assessment using the finite element analysis method.

Finite Element Method (FEM) is a generalized numerical method for solving differential equations accomplished by subdividing a complex system into smaller, simpler parts called “finite elements.”

Lattice means an interconnected matrix of cells, voxels, or Svoxels that replace a solid internal volume.

Triply periodic minimal surface (TPMS) means a minimal surface that is the same over a rank 3 lattice of translations, e.g., a gyroid. TPMS structures have no self-intersecting surfaces and create two separate sub-volumes.

Periodicity means the rate at which a TPMS structure repeats in the three spatial directions. Periodicity is equivalent to cell size for voxel-based lattice structures.

Artificial intelligence (AI) means the use of computers to emulate human cognitive functions. AI therefore refers to the use of machines to accomplish tasks via algorithms in a manner similar to human intelligence.

Machine learning (ML) means a subset of AI wherein machines execute algorithms allowing the machines to receive a set of data, learn from the data, and change algorithms based on the information learned.

AI and ML each refer to multiple techniques rather than a single method of computing.

Supervised learning means the use of labeled training data to perform a machine learning task such as data mining.

Unsupervised learning means the use of unlabeled training data to perform a machine learning task.

Boundary condition means engineering approximations representing the interface between a lattice and a constraint on the lattice, e.g., another lattice, reaction forces, fixed structural or environmental elements, fixed planes, or the external shell of the structure. The application, or a user, may apply boundary conditions to the structure along with external forces during the design process.

### DETAILED DESCRIPTION

The invention as described herein includes systems and methods for implementing artificial intelligence assisted engineering and design of tools, parts, assemblies, and components. In particular, disclosed herein are techniques for constraining AI-assisted 3-D structural design based on considerations that prevent or degrade the translation of a conceptual design into a useable structure. Such constraints fall into three main categories, and include physics-based constraints, geometric constraints, and manufacturing constraints. By limiting AI models according to constraints using the disclosed techniques, the AI models will more reliably output designs that, when rendered as structures through the use of additive manufacturing equipment or other manufacturing techniques, possess the specified characteristics driving the design process.

Embodiments of the disclosed invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the disclosed invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the disclosed invention are provided for illustration purposes only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting,” “mounted,” etc., another element, it can be directly on, attached to, connected to, coupled with, or contacting the other element or intervening elements may also be present. In contrast, when an element is referred to as being, for example, “directly on,” “directly attached” to, “directly connected” to, “directly coupled” with, or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper,” and the like may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal,” and the like are used herein for the purpose of explanation only unless specifically indicated otherwise.

Included in the description are flowcharts and block diagrams depicting examples of the methodology and components which may be used to provide algorithm-aided design of structures. In the following description, it will be understood that each block of such illustrations, and combinations of blocks in such illustrations, can be implemented by computer program instructions. These computer program instructions may be loaded onto a computer or other programmable apparatus to produce a machine such that the instructions that execute on the computer or other programmable apparatus create means for implementing the functions specified in the illustration block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the illustration block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the illustration block or blocks.

Accordingly, blocks of the flowchart and block diagram illustrations support combinations of means for performing the specified functions and/or combinations of steps for performing the specified functions. It will also be understood that each block of the illustrations, and combinations of blocks in the illustrations, can be implemented by general or special purpose hardware-based computer systems that perform the specified functions or steps, or combinations of hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words,” or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

### SOFTWARE APPLICATION

Embodiments of the disclosed systems and methods include an application configured to run on a computing device, such as a tablet, laptop, desktop, or other device. The computer configured to run the application includes aspects commonly known in the art, including a central processor, working memory for the processor, a visual display, an input means, such as a mouse, keyboard, and/or touchscreen, and data storage means. The application includes pages that are accessible on a display of the computing device, and which provide information to and solicit input from the application user. The application accepts inputs from a user to enable a design process for a three-dimensional (3-D) structure, and outputs candidate designs for selection by the user. Embodiments of the application output designs for use on an additive manufacturing device for printing with a specified material.

### PHYSICS-BASED CONSTRAINTS

In some embodiments of the disclosed invention, a primary means of producing designs for structures that satisfy multiple design criteria is the use of relationships required by the laws of physics to constrain the AI models. Physics constraints may take the form of mathematical equations, e.g., the dampened oscillator equation for vibration, or may take the form of empirical constraints, e.g., experimentally generated databases that express a constraint based on the principals, theorems, and laws of physics.

### PHYSICS CONSTRAINTS: MATHEMATICAL CONSTRAINTS ON MODELS

In some embodiments, physics-based constraints include constraining AI models used for structural design according to mathematical relationships among various design factors. Chiefly, such constraints involve balancing competing requirements imposed by mathematical equations onto the structural design, and selecting viable candidate designs to present to a user for evaluation.

### MATHEMATICAL CONSTRAINTS: SELECTING FOR TWO VARIABLES

Some embodiments impose mathematical constraints on models by performing primary optimization of a single variable and then using secondary sorting to select for a second variable. For example, candidate designs may be optimized to promote thermal conductivity, and then the resulting candidate designs are sorted according to stiffness characteristics of the structures. As another example, candidate designs may be optimized to minimize thermal conductivity, and the resulting candidate designs sorted according to those structures displaying the best electrical conductivity.

In cases where two variables have equal value to the user, simultaneous optimization of the variables may be performed. For example, a model may be configured to generate candidate structures that concurrently maximize thermal conductivity while optimizing for minimal lattice interconnection. Similarly, the process may concurrently minimize thermal conductivity while concurrently maximizing stiffness or electrical conductivity.

Either of the two variable selection techniques (primary first then secondary, or both concurrently) may be used to design structures having two complementary or competing performance requirements. For example, electronic components that ideally have low thermal conductivity and high electrical conductivity, or heat exchangers that ideally have high thermal conductivity while maintaining structural stiffness or minimizing weight.

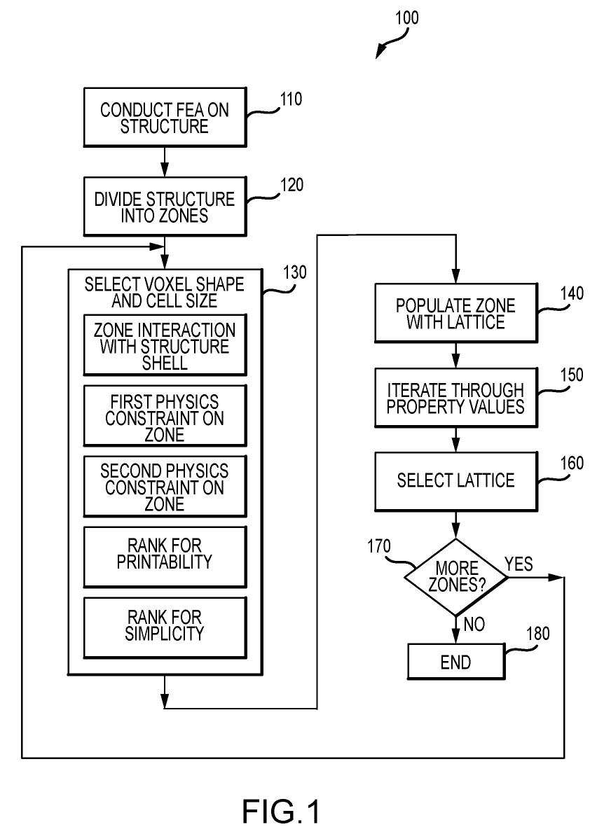

With reference to FIG. 1 is depicted a flow chart 100 depicting an exemplary method for designing a three-dimensional (3-D) structure to satisfy two performance variables. Initially, the external forces on the structure must be determined 110. For example, the system application may conduct a finite element analysis (FEA) on the structure, or in some embodiments, a user performs such analysis and supplies the results to the application. By use of FEA, locations within the structure are identified that experience, e.g., high stress and strain forces, or relatively low stress and strain. Other physics constraints, such as vibration, thermal conductivity, electrical conductivity, etc., may be evaluated first depending on the requirements of the structure. A location experiencing high levels of the physics constraint may be identified as a first zone, while an area experiencing relatively lower levels may be designated a second zone. In this way, the structure is divided into zones 120 based on the magnitude or direction of external forces predominantly experienced in the zone. Each zone may then be populated with a lattice separately using constraints appropriate to that zone. Such division of the build space results in separate and interconnected zones, each of which has a lattice that is tuned to the local properties primarily required for the lattice in that location, e.g., stiffness requirements in one location versus shear strength in another adjacent location.

The application then selects a base voxel shape and cell size 130 for each zone. The selection process includes accounting for the interaction between the zone and the exterior shell shape, which affects how the voxels are packed into the zone. An application user may also provide input to select the lattice shape and or cell size for the application to start the filtering process for baseline lattice selection. Next, the application runs an AI model to evaluate the effects of a first physics constraint on the zone, e.g., stress and strain. The application then runs an AI model to evaluate the secondary effects, i.e., thermal transfer requirements on the zone. In some embodiments, rather than evaluate the secondary constraint by use of an AI model, the application offers to the user candidate designs that satisfy the first constraint and the secondary constraint to varying degrees, and the user chooses a candidate design that best suits the user’s requirements. An AI model may be trained to evaluate a specific voxel shape, or the same AI model may be trained for multiple shapes. Alternatively, an AI model may be trained to evaluate a specific physics constraint on a single voxel shape. Cell size will typically be determined by packing characteristics of the zone within the outer shell of the part. The default cell sizes are 10 mm, 20 mm, 30 mm, and 50 mm. The application is capable of using the default sizes or can interpolate between the default sizes.

Next, the application assesses the manufacturability or printability of the remaining lattice shape and cell size combinations and ranks the lattices according to suitability or ease of printing for the printer to be used and the material selected for the structure. The application also ranks the remaining lattices according to simplicity, with simple or well-characterized shapes ranked highest and more complicated or less-characterized shapes ranked lower. With a base voxel shape and cell size selected, the application then populates the zone with the base lattice 140.

Beam thickness will typically be the variable that is incrementally adjusted to produce candidate options. During modeling, the application incrementally adjusts 150 the beam thickness, or other suitable property, within the zone in order to identify the beam thicknesses that will support the required primary constraint and the required secondary performance criterion. When incrementing through solutions based on increasing beam thickness, the application also adjusts cell sizes accordingly. The model uses an adjustable ratio between beam thicknesses and cell sizes within the lattice. A common default ratio is use of a beam thickness that is 15% of cell size.

By incrementing through different property values, the application identifies candidate designs that satisfy the primary and secondary constraints, and a lattice is selected for the zone 160. The selection of a candidate design for the zone may be accomplished by the application itself, or the candidate designs may be presented to a user for final selection. The application then inquires whether there are additional zones within the structures that need to be populated with lattice. If so, the application turns to the next zone and selects a base voxel shape and cell size for that zone, and so on. Once all the zones are populated with lattice, the process is complete 180.

As an example of a two variable selection technique, a medical device may be designed with an articulating jaw structure that includes an RF electrode and has limited thermal conductivity and high electrical conductivity. Meanwhile, it also includes a stationary jaw requiring high stiffness and low thermal conductivity.

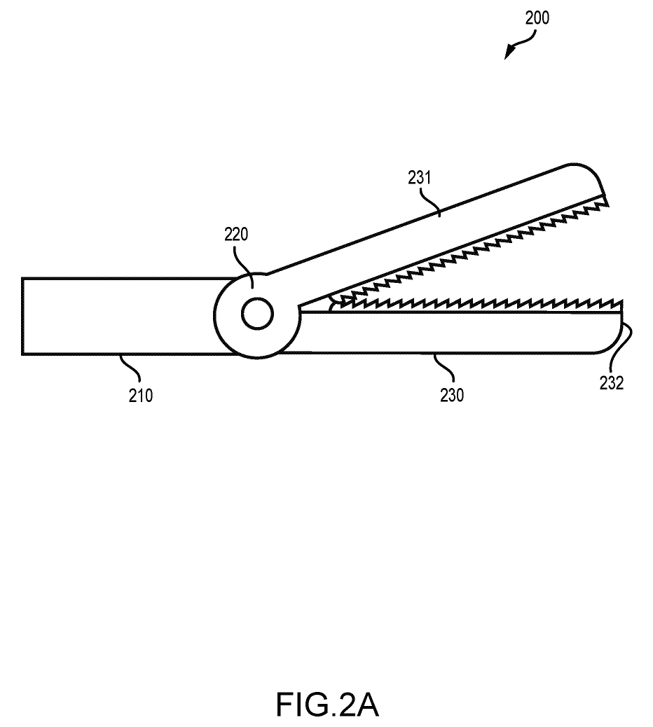

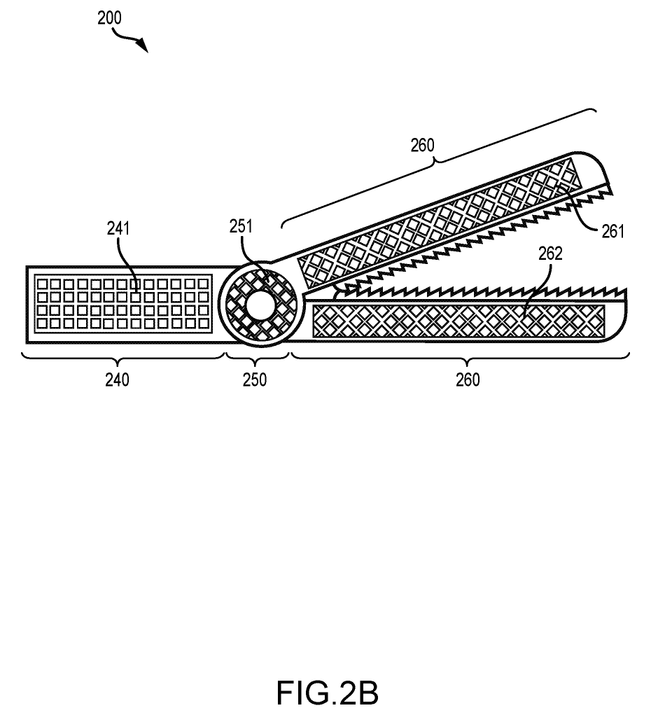

Assume a laparoscopic device with dimensions of 40 millimeter (mm) long by 20 mm high by 12 mm wide. With reference to FIGS. 2A and 2B, is depicted an exemplary laparoscopic device 200 with structure designed according to embodiments of the disclosed invention. The device includes a 10 mm tail 210 on a proximal end, and a 30 mm jaw clamp 230 on the distal end for interacting with the tissue of a patient. The device also includes an interface between the tail and jaw clamp that includes a pivotal joint 220 about which the articulable jaw 231 moves. The jaw clamp 230 is configured to use electromagnetic energy in the radio frequency range (3 kilohertz (KHz) to 300 gigahertz (GHz)) to perform tissue ablation procedures. The articulable upper jaw includes an electrode for transmission of RF current, and a return path on stationary lower jaw 232. As current flows from the upper jaw to the lower jaw, it passes through tissue, thereby heating the tissue to between 160 degrees Celsius (°C) to 180°C.

In addition to conducting electrical current, the jaws must also minimize thermal transfer from the tissue into the jaws, and the jaws must be able to provide 15 pounds per square inch (psi) to 30 psi of clamping pressure on the tissue. To design the device, the primary optimization factor, stress and strain, will target 70% of the best-case configuration, and the secondary sorting factor, thermal transfer, will target 30% of the best-case configuration.

By conducting a finite element analysis on the structure, the system identifies locations within the device that experience high stress and strain forces. These high stress locations may then be latticed separately using different constraints than are used for locations experiencing lower stress and strain.

With reference to FIG. 2B, a portion of the tail extending from the pivot interface is designated Zone 1240 and is assigned Lattice 1241. Zone 1 requires axial strength and can accommodate some shaft bending; therefore Zone 1 may be structured to reduce weight and allow axial stretch. The interface between the tail section and jaw clamp is designated Zone 2250 and assigned Lattice 2251. Zone 2 experiences the highest stress and elongation forces since it serves as the fulcrum supporting the forces on the jaw. The upper and lower jaws are designated Zone 3 260 and are assigned Lattice 3261, 262. Zone 3 experiences the highest thermal effects and lower levels of stress and strain.

The application then assigns each zone a base voxel size and shape based on 1) the exterior shell shape, which affects how the voxels are packed into the zone, 2) the stress and strain on the zone, and 3) the secondary effects, i.e., thermal transfer requirements. Each voxel shape may have its own AI model, or an AI model may be equipped to evaluate more than one shape. Cell size will typically be determined by packing characteristics within the outer shell of the part. The default voxel sizes are 10 mm, 20 mm, 30 mm, and 50 mm. The application is capable of using the default sizes or can interpolate between the default sizes. The smallest cell size may be 1 mm or 5 mm and is limited by the resolution of the additive manufacturing device. Beam thickness will typically be the variable that is incrementally adjusted to produce candidate options.

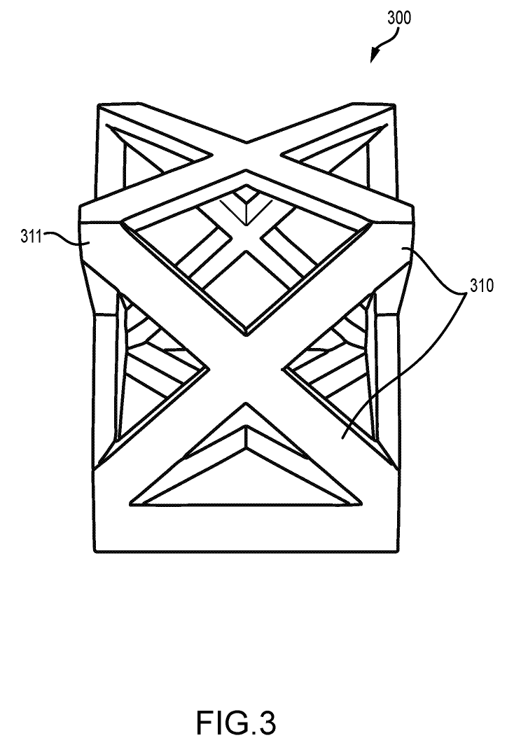

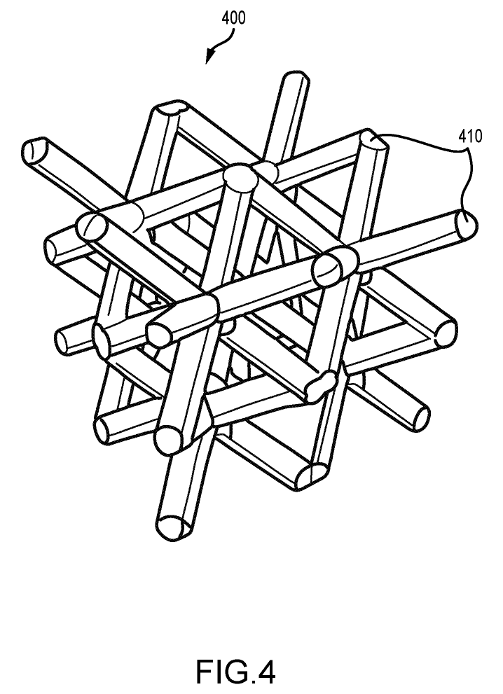

In this example, Zone 1 is populated with a face centered cubic (FCC), lattice shape 241 to provide a high stiffness capability, 1 mm cell size, and a starting beam thickness of 0.5 mm. With reference to FIG. 3, is depicted an exemplary FCC shape 300 as used in embodiments of the disclosed invention. Starting beam thickness may be set, for example, to the minimum thickness the additive manufacturing device is capable of printing when using a titanium powder. Zone 2 will be populated with BCC lattice 251, a lattice shape that accommodates high stress levels, since Zone 2 sees the highest stress, cell sizes of 1.0 mm and 5.0 mm, and a 0.5 mm starting beam thickness. The application populates Zone 3 with a body-centered cubic (BCC) lattice shape 261, cell sizes of 1.0 mm and 5.0 mm, and a starting beam thickness of 0.5 mm. With reference to FIG. 4 is depicted an exemplary BCC shape 400 as used in embodiments of the disclosed invention.

During modeling, the application incrementally adjusts the beam thickness within each of the zones in order to identify the beam thicknesses that will support the required forces and provide the required thermal effects. When incrementing through solutions based on increasing beam thickness, the application also adjusts cell sizes accordingly.

The step interval between beam thickness increments is based on the capabilities of the 3-D printer when used with the material selected for the structure. For example, a particular printer using titanium powder may be able to increment by 0.08 mm, however, such a small step is unlikely to be repeatably produced without defects, and the effects on the lattice for each increment likely cannot be measured accurately. Because of such considerations, a step size of 0.20 mm would be preferred to balance incremental cell size, printer capabilities, and operator skill.

In some embodiments a safety factor based on printer capability may be used to set the minimum beam thickness. Outputs from 3-D printers will experience variations due to the environmental variations. For a particular type of additive manufacturing device, a particular device, or a particular material, empirical studies may reveal a typical amount of variation caused by environmental factors. With known variations in hand, a safety factor is incorporated into one or more characteristics of the candidate design to ensure adequate performance. For example, assume variations in humidity cause a 10% variation in the performance of a structure when printed with a certain 3-D printer device. In response, the application may add a safety factor to the recommended beam thickness to ensure that even if the design is weaker than predicted due to environmental variations, it will still meet performance requirements. As another example, assume two standard deviations of 100% of the target is about 53% of the size of the beam. To ensure variations do not reduce performance below acceptable levels, the starting beam thickness may be increased by the amount equivalent to 53% of the target beam thickness plus two standard deviations.

Zones having higher stress requirements would likely require a different base shape, higher beam thicknesses, and smaller cell sizes. Therefore, each zone will have a preferred voxel shape, and different starting sizes, and will have a step increment based on the preferred shape.

For Zone 1, the model may increment up to 1.9 mm, 2.1 mm, and 2.3 mm to accommodate the stress and strain levels in that zone. For Zone 2, the application may determine that beam thicknesses of 1.5 mm, 1.7 mm, and 1.9 mm are all viable options. For Zone 3, the application may stop at 1.5 mm beam thickness, since the smallest beam thickness is the best for mitigating thermal effects and this zone does not experience substantial stress or strain. For Zone 4, the application may begin with solutions that work for a 1.9 mm beam thickness and increment up to a fully solid build.

After each iteration of beam thickness increases, the application may use the secondary thermal effects requirement to balance priorities, or to eliminate certain candidate shapes, cell sizes, or beam thicknesses. The application may then repeat this process for each candidate lattice shape. By iterating through the various available candidates, the application produces a list of workable builds that meet the requirements for part size, stress and strain tolerance, and thermal performance. The application may then present such options to the user in various formats, e.g., a ranked format, wherein the options are ranked according to selected criteria, such as printer capability, performance, cost, etc., If the application is unable to identify a minimum number of viable candidates, the application may return to the iteration process and modify its parameters to produce more viable options. For example, the step increment may be reduced, the beam thickness to cell size ratio may be altered, additional zones may be added to the part, etc.

As another example, a design may optimize natural frequency dampening and then candidate designs are sorted according to stiffness properties. Such optimization may be used to design wind turbine blades that maintain stiffness while minimizing the resonant vibration that emerges at operational rotation speeds. Likewise, candidate structures may be designed to minimize mass and then sorted according to stiffness. Or candidate structures may be designed to absorb maximum energy before collapse and then sorted according to stiffness. This type of optimization may be used to create ballistic armor, or to design crush zones for automobiles. Through such techniques, several viable options may be produced, allowing a user to select among the candidate designs to favor other desirable characteristics, such as material cost, complexity, weight, etc.

### MATHEMATICAL CONSTRAINTS: MULTIPLE CANDIDATE OPTIMIZATION

Some embodiments of the disclosed invention impose mathematical constraints on AI models by use of decision-making techniques to identify multiple viable candidate designs that include an optimal candidate design.

One such approach is to determine a maximum viable primary performance that is acceptable given its effect on the acceptability of the secondary parameter. For example, the application may produce a candidate design that satisfies the primary constraint by 95%, while satisfying a secondary constraint by 10%. The user may then be provided the opportunity to accept the design based on the respective performance of the design on the primary and secondary parameters.

As an exemplary approach to performing multiple candidate optimization, given designs using three voxel sizes, three lattice structures, and variable beam thickness, the application will select those structures most likely to succeed for the given material and printer. The application will look for similar sizes and cell types that have a likelihood of succeeding based on previous learnings by relevant models. Once lattice shape and cell size are selected, the model explores variations in beam thicknesses that produce the specified loading capabilities. Once the initial candidate designs are selected, the application evaluates printability factors to narrow the options further. The application then presents the user with multiple options that satisfy explicit parameters. Selecting from among these viable candidate options allows the user to select for other considerations not addressed by the model.

Some embodiments of the system limit cell sizes to default factors of 10 mm, 20 mm, 30 mm, and 50 mm. AI models trained on datasets where cell sizes are factors of these defaults will output solutions that always include these sizes, or a ratio of 1:2:3:5 as available options for voxel size. Beam thickness may be incremented according to structural loading requirements, but the voxel size will always be one of the above sizes and the viable options will always be part of the ratio set. If AI models trained on such datasets are used instead to output solutions that interpolate between the default size increments, inaccurate designs will result. For example, the error could be +/- 20%. Practical analysis of candidate structures using general FEA has revealed that the application tends to produce solutions that overestimate the incremental capabilities of the lattice when using interpolated cell sizes. Results found that solution strength was only 80% accurate compared to the actual manufactured parts.

To construct a structure, data used for AI model training includes 8 to 10 Svoxels or cells. Use of multiple cells results in an overall weaker structure than a structure comprised of a single cell. Structures having 8 to 10 cells are on average 10% weaker than a structure having only a single cell. Such weakness is likely the result of defects in the manufacturing process that manifest as more cells are included in the design. With more cells, the probability of defects increases. Defects in one or more cells translates to poorer performance of the structure. Overall model performance is the average of each cell’s performance. Therefore, performance of a structure having a single cell is just the performance of that cell, where the performance of a structure having 10 cells is the average of each cell’s performance.

The base beam thickness typically starts at 1.5 mm and is increased as needed to support the loading as calculated through the initial FEA. Depending on the lattice shape, a maximum beam size will result in a solid voxel. For example, assume a lattice shape that is a cubic frame, with no internal beams. When beam thickness in such a shape reaches 50% of the cell size, the voxel will be solid, with no open internal space. For lattice shapes with internal beams, a beam thickness less than 50% of the cell size will result in a solid voxel. Because of this, the application will set the AI model to exclude solutions that are more than a threshold ratio of solid to empty space. For example, solid space may be limited to 80%, giving a maximum solid-to-empty space ratio of 80:20. The beam size would accordingly be limited to avoid exceeding the threshold ratio for solid to empty space.

In some embodiments, the user and the application fill different roles in the identification and selection of multiple viable candidate designs. For example, in some cases the user may perform definition and selection around the design’s physics constraints, while the application accounts for interrelationships among the constraints, or accounts for boundary conditions. In cases where multiple physics constraints are imposed on a design, the user may weigh the physics constraints, i.e., determine which is a primary or secondary constraint, or determine the percentage of viability for a selected physics constraint, while the application adjusts overall viability weights to prevent overweighting coupled requirements. To select the resulting candidate structures, the application may examine, e.g., load, thermal conductivity, or natural frequency, and outputs results that concurrently compare and sort all three constraints. The user then defines the primary physics constraint by selecting from among the presented options on the basis of the required viability percentage for the selected primary constraint.

In some embodiments, another method used to identify multiple viable candidate designs is to perform primary optimization around one physics constraint and then perform a secondary optimization around a user-selected starting point, wherein the application would perform the secondary optimization process using smaller incremental steps. For example, the application concurrently weighs three physics constraints, and outputs a first-round set of viable candidate designs. The user then selects a subset of the first-round candidate designs based on a user-defined primary physics constraint and instructs the application to re-apply all the filters and re-run the AI model bounded by the shapes and cell sizes found in the subset. The resulting second-round output would provide additional candidate designs similar to the user-selected subset designs but would have finer differentiation of the lattice structures around the second and third physics constraints.

In some embodiments, the system may be configured to score and sort candidate designs based on manufacturability checks applicable to individual designs. Such a sorting protocol would allow the user to assess the manufacturing viability of candidate designs at an early stage of selection. To accomplish such manufacturability scoring, the application selects and then evaluates manufacturability factors that are applicable to the particular design, the printer, and material being used. The application may then allow a user to sort candidate designs based on their manufacturability score.

In some embodiments, logical reasoning may identify multiple viable design candidates. For example, assume that a thicker beam is stronger and vibrates at a higher frequency relative to a thinner beam. During the optimization process, the application produces a candidate design optimized for vibration characteristics having a beam thickness of 1 mm, while optimizing for strength characteristics produces a candidate design with a beam thickness of 6 mm. Logically, beam thicknesses between 1 mm and 6 mm could satisfy both physics constraints and may prove to be acceptable viable candidate designs.

Use of logical techniques to identify multiple viable candidate designs may require the application to set a minimum performance threshold for each physics constraint before a candidate design is qualified for presentation to the user. As an example, one standard deviation from the mean predicted output may be configured to include approximately 68% of the expected distribution of design outcomes. In some embodiments, standard deviations may be taken from a mean or median design, or a predicted design.

The application may implement such a threshold in a number of ways. For example, the application may run an AI model to optimize for a primary physics constraint, and then run the resulting candidate designs through a second AI model to optimize for a secondary physics constraint. Another option is to run a first AI model on the primary constraint and a second AI model on a secondary constraint. The outputs of both AI models may then be cross correlated to identify common candidate designs. The common candidate designs may then be fed into the first and second AI models to produce additional candidate designs that satisfy both constraints. Multiple rounds of optimization and cross-correlation may be performed. Another option is run a single optimization for the primary constraint and then predict boundaries for values likely to yield candidate designs satisfying the secondary constraint. Candidate designs falling outside the boundaries would be rejected. Candidate designs falling within the boundaries may be run through additional rounds of optimization to identify multiple viable candidates.

In some embodiments, multiple viable candidate designs may be identified by the user setting boundaries for the AI model that the user determines are likely to include the desired results. For example, the user may provide the AI model a target acceptance value, e.g., the user specifies a target load bearing value with a safety factor. Candidate designs that greatly exceed the target load capacity are rejected because they add no additional benefit. Similarly, the user may provide the AI model with a target rejection value, e.g., no candidate design may vibrate at the structure’s resonant frequency. Likewise, the model may be provided a target acceptance range, e.g., the candidate design must be viable at all temperatures within a range. Similarly, the model may be provided a target rejection range, e.g., the candidate design must have a natural frequency outside of a specific range to avoid failure.

In some embodiments, the identification of multiple viable candidate designs includes prioritizing and sorting based on optimization goals. For example, assume the application is unable to identify a single candidate design that satisfies all of the physics-based constraints. In such cases, the application may drop the lowest priority physics constraint, and present candidate structures that satisfy the remaining higher priority constraints. Such prioritization may be conducted automatically by the application or may be based on user input. Candidate designs that satisfy the subset of constraints may then be run through an AI model to identify candidate designs that satisfy the low priority physics constraint.

In some embodiments, identification of multiple viable candidates includes interfacing an AI model with a 3-D model sheet for a structural design. As used herein, the 3-D model sheet is a solution set of the primary physics constraint (as selected by the user) mapped against solutions for multiple competing physics constraints. Using the AI model with such a 3-D model sheet allows the application to produce candidate designs that are defined by the results from multiple models, and allows the application to weight constraints that have not been chosen or specified by the user, or alternatively, allows the user to select candidate designs from among solutions that satisfy multiple constraints.

### MATHEMATICAL CONSTRAINTS: THREE FACTOR OPTIMIZATION

Some embodiments of the disclosed invention impose mathematical constraints on models by performing concurrent optimization of three or more variables. Such optimization requires the application to perform decision making processes to select among candidate designs having two or more secondary constraints. In some cases, the user may provide a hierarchy for the secondary constraints. The application would produce candidate designs that prioritize candidate designs that optimize the physics constraints according to their place in the hierarchy.

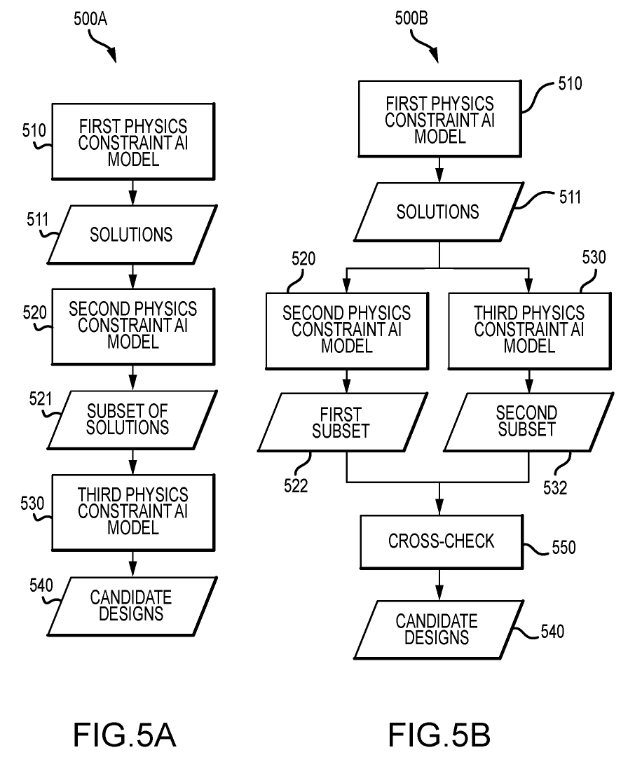

With reference to FIG. 5A is depicted a flow chart 500A showing an exemplary method of designing a three-dimensional structure according to three physics constraints. The application includes an AI model trained to solve for each physics constraint that controls a user’s requirements for a structure. A user selects a primary constraint and then ranks the secondary constraints and provides the hierarchy as an input to the application. The application then runs the AI model for the primary constraint 510 and develops solutions 511 as the model’s output. These solutions are then used as inputs for AI models for the secondary constraints. The secondary models may then be run in a cascade. The solutions 511 from the first AI model are provided as inputs to the second physics constraint AI model 520, which produces a subset 521 of those solutions that satisfy both the first and second constraints as an output. The subset of solutions 521 is then fed as an input to third physics constraint AI model 530, which in turn produces a set of candidate designs 540 that represents those solutions that satisfy all three constraints.

Alternatively, the secondary models can be run concurrently and the outputs crosschecked for compatibility. With reference to FIG. 5B is depicted a flow chart 500B showing an alternative method of designing a three-dimensional structure according to three physics constraints. In such embodiments, the primary AI model 510 provides solutions 511 to the first physics constraint, and the solutions are fed concurrently to the second physics constraint AI model 520, and the third physics constraint AI model 530. Each secondary model produces a subset of the solutions, i.e., the second AI model produces a first subset 522 that includes solutions that satisfy the first and second physics constraints, and the third AI model produces a second subset 532 that includes solutions that satisfy the first and third physics constraints. The first and second subsets 522, 532 are then crosschecked 550 to identify common solutions. Such common solutions are then presented as candidate designs 540.

In some embodiments, the system may be configured so that a single AI model is capable of solving for three or more physics constraints concurrently. However, it is not possible to know beforehand whether or not such an all-in-one model will converge on a solution.

In other cases, the application may generate no viable candidate designs or may produce below a minimum number of viable designs. For example, assume the application is tasked to optimize one primary factor and three secondary factors, and the application subsequently outputs less than a minimum number of candidate designs. One solution requires the user to expand the target value or range for a constraint. For example, if the user originally imposed a static loading requirement of 100 pounds, the user may expand the requirement to 110 pounds +/- 5% to provide the AI model additional options that still provide the required performance on the primary constraint. As another example, the application may define a relevant performance aspect that the user has not specified, such as the weight of a structure, when the user is optimizing for strength and resonant frequency. In such cases, the application may specify the weight of each candidate design, allowing the user to consider the additional constraint when evaluating the candidate designs.

In some embodiments, structural design takes place in a high-dimensional space wherein solving for lattice shapes or TPMS structures involves a vast number of parameters, including geometry, material properties, and functional requirements. Traditional machine learning has difficulty solving for three-dimensional or higher space, resulting in stretched or distorted shapes. To address such shortcomings, the application uses simplification techniques to address high dimensional design parameters while preventing stretched or distorted outputs.

For example, the application may run a dataset with three or more input parameters through multiple AI models. Each AI model solves for a subset of constraints in two-dimensional space, and the outputs of each AI model are compared. Solutions that are shared among multiple AI models are identified and selected. Common solutions may then be run through multiple AI models again for further optimization.

As another example, the three-dimensional structure of an Svoxel may be simplified to two dimensions, allowing the AI model identify patterns and trends that can then be extrapolated to higher dimensional space. Similarly, the AI model may be instructed to assume Svoxel structures do not stretch or distort under stress. Through such simplification of Svoxel behavioral properties, the task of identifying viable design solutions is mathematically simplified.

### MATHEMATICAL CONSTRAINTS: FILTERING MASK TECHNIQUES

Some embodiments of the disclosed invention impose mathematical constraints on models by using the organization of layers of cells as a filtering mask to advance designs accounting for one type of physics, e.g., stress-strain, versus a competing type of physics, e.g., thermal conductivity, vibration, or electrical conductivity. To do so, the application must clearly differentiate among different aspects of the design components, namely voxel, Svoxel, lattice, voxel-to-voxel interface, and voxel-to-external shell interface.

One such organizational concept for construction of designs is unidirectionality, meaning a voxel or Svoxel may have a performance characteristic that propagates within a single axis direction. If directional performance is not inherent to the voxel structure, voxel-to-voxel interface conditions may be varied to propagate effects in a single direction while preventing the propagation of effects in the opposite direction. For example, unidirectionality in thermal transmissibility may be used to protect against hot spots. The bulk of the lattice may be configured to promote thermal conductivity outward, while beam thickness may also be arranged to move heat in the opposite direction away from a potential hot spot. Similarly, a standard voxel shape may be altered to have a functional gradient by adding a unidirectional parameter to the voxel shape. Another way to introduce unidirectionality is to alter a single voxel, e.g., the beam thickness of a single beam of a single voxel is varied to develop the candidate design. Altering standard shapes and adding additional parameters requires the use of more processing power or may require the use of simplification techniques. Use of non-standard shapes also compromises the fidelity of the AI model, since training data will typically not include such changes to standard shapes.

Another option to introduce directionality is to apply a gradient to beam thickness, for example by continuously varying the beam thickness along its length according to a function equation. However, use of continuous variance requires even more processing power than discretization and carries a higher risk to the fidelity of the AI model.

Use of unidirectionality introduces further difficulties for the system, including the necessity to prevent the emergence of discontinuities, and to prevent “hot spots,” e.g., localized stress, strain, thermal, or vibratory issues, from affecting the larger structure. For example, the inclusion of a discretized change to a single voxel in a structure may alter the heat transfer properties of the structure, for instance, if the altered voxel includes smaller beams with inferior heat transfer characteristics than the remainder of the structure. A mitigation technique is to include a transition layer or transitional voxels in the vicinity of the discretized voxel to inhibit communication of the undesirable properties to the remainder of the structure. To construct structures with multiple regions, the space may be divided into smaller regions and solved by an AI model independently for the primary constraint, then the regional solutions may be re-assembled to comprise a solution for the original space. Boundary solutions between regions may then be used to filter for the secondary constraint.

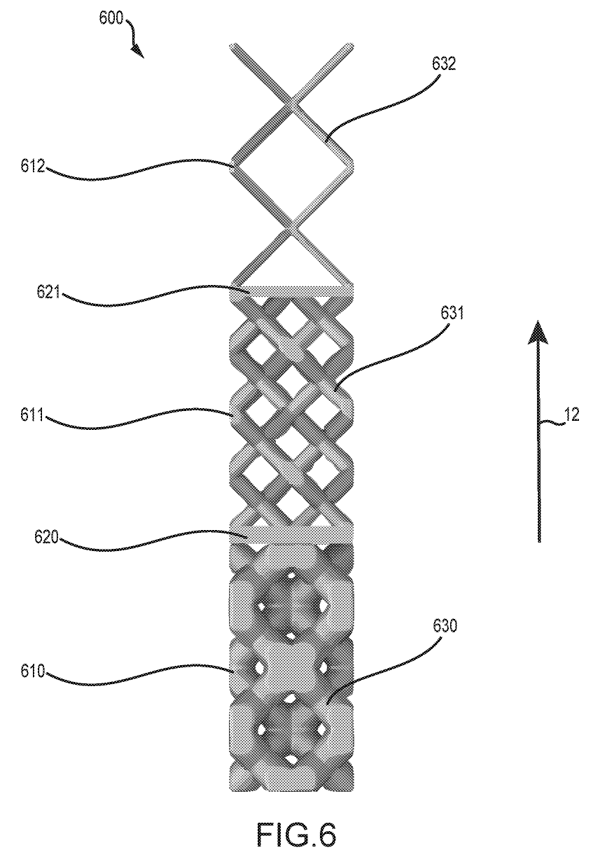

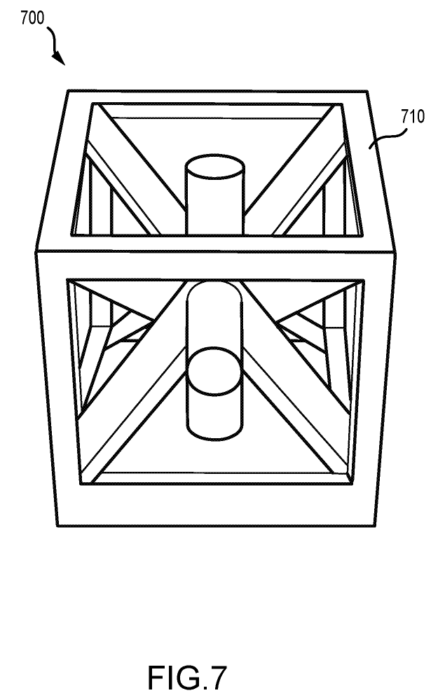

Another filtering mask technique is to control for heterogeneity or homogeneity of physics constraints across the structure. For example, a directional heat gating lattice is a structure designed to conduct internally created heat outward homogeneously, while minimizing the ability for surface hot spots to propagate inwardly into the structure. A directional gating lattice may be designed with beam thicknesses near the external surface that are relatively small, while internal lattice beam thicknesses are relatively large. With reference to FIG. 6 is depicted a modified lattice shape 600 with a directional heat gating structure. Beam thicknesses 632 near the external surface are smaller, while beam thicknesses 630 near the internal surface are larger. Such a structure would allow heat concentrated in an innermost area to propagate outward in the direction of the arrow 12 across a large portion of the external structure, while making it difficult for heat concentrated in external hot spots to propagate inward. In this way, variations in beam thickness may be used to control heat transfer from one layer to the next. Larger beam cross sections allow for more heat transfer, while smaller cross sections inhibit heat transfer.

Directional heat gating may be used for aerospace applications. For instance, jet engine structures may be manipulated to allow heat to propagate freely from a turbine’s blade leading edge inwardly to promote cooling, while also inhibiting transfer outward to adjacent engine components.

Similarly, gradients may also be used to control heat propagation. Gradient changes may be located either mid-beam or where a beam intersects with an adjacent layer of voxels. Gradients may be used to encourage or discourage heat transfer by use of increasing or decreasing gradients, respectively. Local geometric manipulation may be used systematically across an entire structure to shape thermal capacity and heat transfer thereby enabling control of thermal gradients throughout the structure.

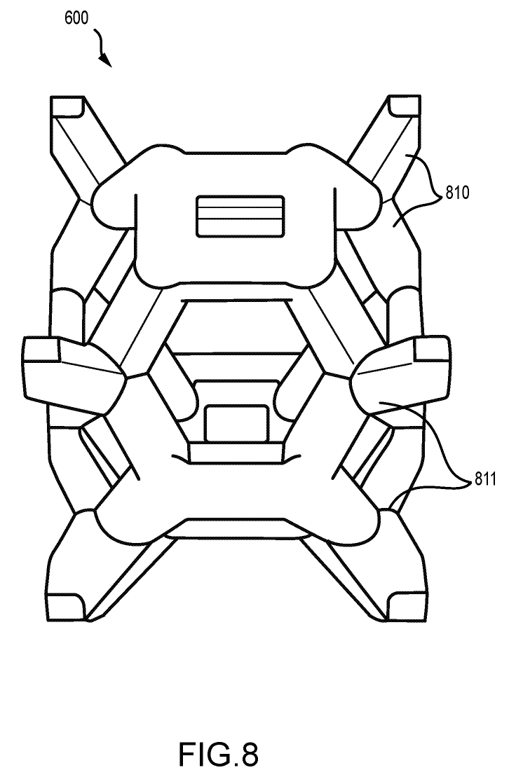

Heat exchange from layer to layer also may be manipulated by varying the number and size of interconnections between voxel layers. One means of affecting layer-to-layer heat transfer is through choice of voxel shape. BBC shapes have relatively more layer-to-layer interconnections, which will encourage more transfer between layers. By contrast, FCC shapes have relatively fewer layer-to-layer interconnections, which discourages heat transfer. Similarly, use of a smaller cell size will increase interconnections between layers, increasing heat transfer. Likewise, voxels with external frames tend to have better heat transfer properties. With reference to FIG. 7 is depicted a voxel shape 700 with an added external frame 710, as used in embodiments of the disclosed invention. By adding an external frame to a voxel shape with lower heat transfer properties, the heat transfer capability of a shape is increased.

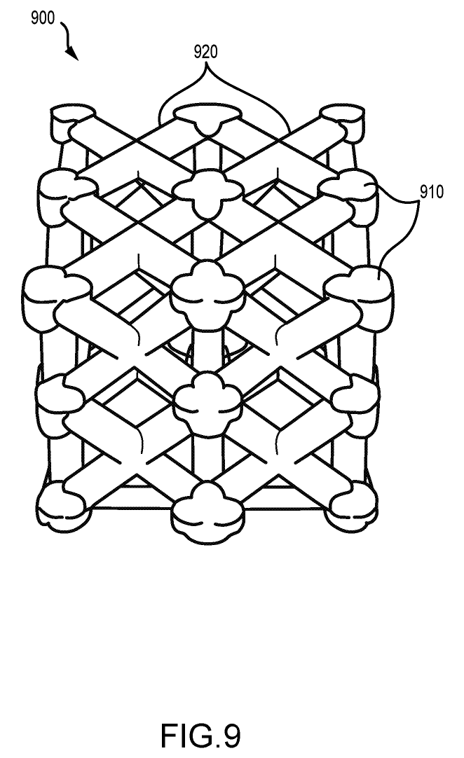

Another technique is to use a specialty fluorite lattice to increase the number of interconnections within a voxel, or between voxels, to increase transfer of heat through and between voxels. With reference to FIG. 8 is depicted an exemplary fluorite lattice shape 800 as is used in embodiments of the disclosed invention. The size of interconnection joints may also be used to influence heat transfer properties. For example, joints that are larger than the beam thickness tends to improve heat transfer, while use of joints that are smaller than the beam cross-section decreases heat transfer. With reference to FIG. 9 is depicted a modified lattice shape 900 that includes joints 910 that have a larger cross section than the thickness of the beams 920.

Another means of introducing thermal directionality to a structure is by inserting a transitional layer between lattice layers, wherein the transitional layer has more horizontal connections than vertical connections. The horizontal connections will tend to distribute the heat throughout the transitional layer, while the reduced vertical connections will limit heat transfer through the transitional layer to the next layer of the lattice.

For example, assume the need to design a turbine blade having an outer skin that is thicker than the beams of its internal lattice. During part design, a BCC shape may be recommended due to strength and stress requirements. However, BCC shapes tend to encourage heat transfer, which is undesirable for the turbine blade. To control heat transfer properties, the sub-lattice may be divided into two areas separated by a transition layer having FCC shapes. In such a configuration, the outer BCC layer would absorb and distribute much of the thermal energy and distribute mechanical stress. The FCC transition layer would not be under the same mechanical stress and would limit heat transfer from the outer BCC layer to the inner structure. Alternatively, instead of a transition layer having a different voxel shape, a transition layer with an increasing beam thickness gradient may be used to limit heat transfer from the outer lattice to the inner structure. A transition layer combining the use of gradients and different voxel shapes may also be used to magnify the effect of either solution independently.

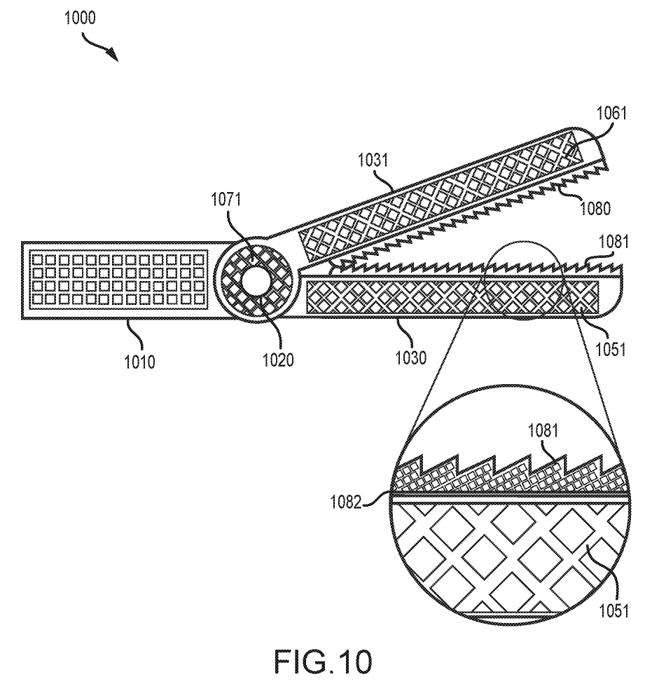

Another example of the use of homogeneity versus heterogeneity is in medical device design. For the laparoscopic device described earlier, the lattice structure of the jaws may be adjusted locally to prevent heat propagation from tissue through the jaws and into the clamp arm. With reference to FIG. 10 is depicted an exemplary laparoscopic device 1000 with structure designed according to embodiments of the disclosed invention. Assume the same structural requirements as described above for the laparoscopic device, with an additional requirement to minimize thermal transfer from jaw surfaces 1080, 1081 into the remainder of the jaw. To promote RF conductivity, the selected build material may be titanium or a titanium alloy. The main body 1061 of the upper jaw 1031 may be constructed of a BCC lattice to minimize mass and improve stiffness. In the high stress areas 1071 near the jaw joint 1020, the structure may include beams with large cross sections, or a fluorite lattice may be used to minimize deflection and strain from contact with the lower jaw 1030, and the moment transferred from the tail section 1010 to drive the clamping force between the jaws. The upper and lower jaws may be separated by an insulating layer or may be connected by use of an insulated joint.

For surfaces that contact tissue 1080, 1081, an FCC lattice with beams having a smaller cross section may be used. The contact section 1081 does not require the same stiffness or strength performance as the remainder of the jaw structure but relies on the underlying BCC layers of the main jaw structure 1051 for strength and stiffness. The transition zone 1082 between the contact layer and main jaw structure may also be designed to discourage heat transfer from the tissue into the main jaw structure by use of smaller beam cross sections, fewer beam interconnections, beam thickness gradients, or other suitable structural modifications, as described above. The main jaw section 1051 also may be designed to have increased negative space, e.g., more voids, less material, and less interconnections, to limit the mass of the structure and reduce the main jaw’s tendency to serve as a heat sink, which would cause it to draw heat away from the tissue, where the heat is intended to be concentrated.

### PHYSICS-BASED CONSTRAINTS: RANKING PRESENTED OPTIONS

In some embodiments, the application applies physics-based constraints by means of ranking candidate designs in a Graphical User Interface (GUI). The application includes a GUI that uses color-coding to indicate the printability of each candidate design presented to a user. Printability is an assessment of a 3-D printer’s ability to effectively render a design, given the material to be used for the structure. A printability assessment is based on a number of factors, including whether the elements of a design are too small to be resolved by the printer, structure geometry relative to certain print processes, whether spacing among elements is sufficient to allow waste material (if any) to be removed mechanically, whether the structure is too large for the printer, etc. Printability criteria for a specific design also include the resolution of the beams, cells, and surfaces relative to the printer’s minimum capabilities.

Printability also includes whether individual elements of the design may be reliably measured, which affects an AI model’s ability to select for designs that can be reliably printed. The AI model’s ability to select printable candidate designs is in turn dependent on the underlying training dataset that accounts the physics constraint of the model. For example, if a candidate design has a beam cross section that is below an error measurement limit, or if the difference in measurements between one design and another is below such limits, modeling data generated to predict the performance of such designs will be questionable, and the application will accordingly demote the printability rank such designs. Similarly, the application may demote the printability of a design that requires specialized cleaning procedures. The preferred means of removing excess material from a printed structure is by use of mechanical means, e.g., cutters and other tools. However, in some cases a design may require the use of fluids or gasses to remove waste material. Such alternate means are generally more time consuming and less effective than mechanical means and therefore represent a limitation on the printability of a structure, which may reduce the printability ranking of the candidate. In addition, the application may be configured to filter candidate designs that would not be empirically testable based on the manufacturing facility’s testing capabilities, e.g., the design would be heavier than the facility’s scale capacity, stronger than the facility’s testing capability, or having a natural frequency that the facility cannot test. Such filters may be user-defined, including a list of available 3-D printers, a list of unsuitable materials, manufacturing cost ceilings, and other suitable user-set filters.

In some embodiments, the application is configured to display candidate designs in an intuitive order that facilitates a user choice of structure to manufacture. For example, candidate designs may be ranked based on performance relative to the primary physics constraint. Each candidate design’s secondary performance characteristics are output in an accompanying table. The user may then select among the ranked candidates according to the user’s assessment of the combined primary and secondary performance.

In some embodiments, the application combines two or more systems to develop a ranking order based on the predicted printability of candidate designs. In such embodiments, the advanced color-coded ranking system may indicate both the viability limit for the candidate designs within a selected safety factor and may show the proportionate differences between color-defined zones. In this way, the user is able to see the magnitude of performance degradation from one color band to the next. For example, each color band ideally represents a 1.5X to 2.5X (with a range of 1X to 3X) difference in viability. Use of advanced color-coded rankings therefore informs the user of the likely variation among the candidate structures, rather than a simple ranked list of candidates.

### PHYSICS-BASED CONSTRAINTS: EMPIRICAL PHYSICS CONSTRAINTS

In some embodiments, rather than constraining design models according to mathematical physics relations, the disclosed invention includes empirical methods to predict the physical behavior of designs by use of a predefined dataset matrix characterizing variables and their effects. Such methods include the collection of physical testing data to align physics-informed machine learning models with real-world structural behaviors. Empirical results may identify when candidate designs are outside certain parameter ranges. For example, if a user wants to design a structure with a resonant frequency that is outside the range for which sufficient data exists, the application may warn the user to select a resonant frequency for which the AI model has better support, i.e., there is sufficient training data for the selected frequency.

Empirical data collection may therefore be used to filter out candidate designs that are not printable using certain 3-D printers, certain materials, or certain lattice shapes. Printability is dependent on the printer used, construction material, post processing requirements, and geometry of the structure. For example, in some embodiments, the application includes a library of geometries that is used to inform the capabilities of new manufacturing processes, i.e., processes that use a new 3-D printer, a new material, a new lattice shape, or other relevant manufacturing aspect. The library includes standardized evaluation specimens for predicting the performance of designs produced using the new manufacturing process. For example, an evaluation specimen may include multiple beams having different beam thicknesses ranging from 0.1 mm to 2.0 mm in steps of 0.1 mm. The evaluation specimen is printed using the new process to identify printability limits based on the output. Results of such tests are then used build manufacturability filters for candidate designs developed using the new manufacturing process.

There is substantial variation in performance among 3-D printers of different types, and even among different machines of the same type. Variation within a model and class of printer could be as much as 20% but typically is on the order of 10% printer-to-printer. In some embodiments, the application therefore includes a cushion for such variability in the manufacturability filters to allow structures to be printed on machines that have not been empirically tested. Inclusion of a printer-to-printer variability factor thus improves the manufacturability of candidate designs across multiple manufacturing sites, or when outsourcing a manufacturing order to third-party suppliers.

In some embodiments, the application includes a safety factor to account for various types of errors that may degrade the printability of a candidate design. Determining the appropriate magnitude of a safety factor for a particular manufacturing process is dependent on the characteristics of the process and may be generally expressed as falling in a range between a worst-case scenario and a best-case scenario. Relevant characteristics affecting the magnitude of the safety factor include printer operator factors, such as operator skill, or difficulty of waste material removal. Other factors concern the printer itself, such as nozzle diameter, platform size, volume limitations, resolution, or accommodated powder diameters. Safety factor magnitude may also depend on structure size or lattice configuration, which may affect the difficulty of removing waste material.

The safety factor may also be used to ensure a candidate design remains above structural and build error limitations of a given manufacturing process. For example, the application or a user may set a manufacturability threshold based on error rates. If the predicted number of errors increases substantially below a certain beam thickness, that thickness may be designated as a threshold. As another example, after a structure is printed, its actual beam cross sections are empirically measured and compared to the expected cross sections of the design. If the actual and expected beam thickness diverge at a higher rate below a certain beam size, that size may be set as a threshold.

In other cases, a threshold may be set at a point wherein the error rate increases non-proportionally to the step size between iterations. For example, the application may require linear or predictable exponential changes in performance from one iteration to another, e.g., beam cross sections are reduced or increased by a step size. As iterations of a structure are tested, the application checks for a linear, or predictable exponential change, in performance between iterations. Only those combinations of lattice geometry and beam cross section that result in a linear or predictable geometric change in strength and/or stiffness, or any other tunable physical parameter, are considered viable candidate designs.

In some embodiments, a user may set custom threshold limits within controlled boundaries. For example, the application may present the user with a default acceptable range of cross beam thickness options that are predicted to be printable within a safety margin. Because the default acceptable range causes the application to filter candidate structures before they are presented to the user, the user may be given the option to accept the default range or expand the range into a less predictable or less stable zone. This would not remove the default threshold limits but would allow the user to go beyond the threshold a certain limited amount and thus see additional candidate designs. For example, the user may be able to expand the range based on a probability of stability, e.g., +/- 10% beyond the default range. The user may be advised that the structure could have defects or other issues or may be provided with printed samples to allow empirical examination to confirm conformance with the expected design. Other suitable means of setting manufacturability thresholds are possible and contemplated.

### GEOMETRIC CONSTRAINTS

In some embodiments, the disclosed invention also includes systems and methods to impose constraints on designs according to the geometry of the structure, i.e., geometric constraints.

### GEOMETRIC CONSTRAINTS: INTERACTION OF OUTER SHELL WITH INTERNAL STRUCTURE

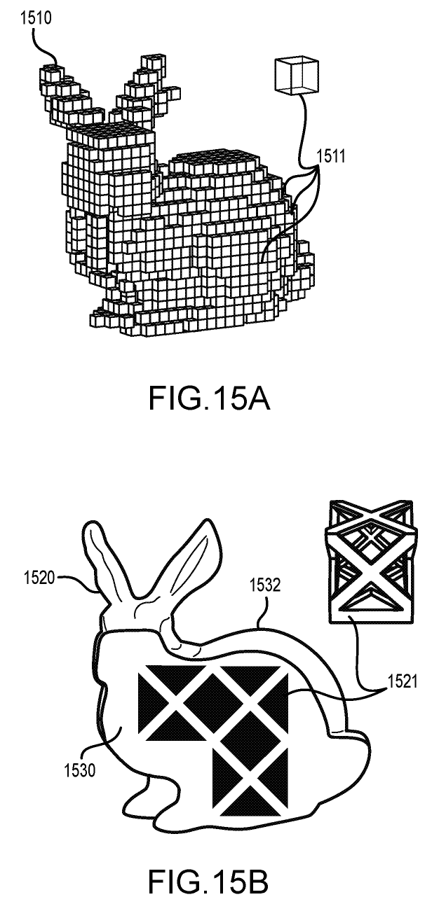

One such geometric constraint includes the geometry of the interface between the internal voxelated build space and the external surface or shell of the structure. Embodiments of the system are equipped to address various issues when integrating the internal lattice structure with the external shell. One such issue is managing the integration of portions of the shell that are smaller than the cell size used to construct the internal lattice. In these areas, one solution is to increase the shell thickness to fill the volume with solid material. Another approach is to adjust the size of voxels at the interface between the lattice and shell to use complete voxels, even if the voxel size must be reduced. For example, see the discussion around FIGS. 15A and 15B below. Another solution is to change the voxel shape at the interface to allow for a partial voxel to be placed in the area while maintaining structural interconnections with the main lattice structure. For example, a BCC lattice shape may be bisected so that the center interconnection and the perimeter frame maintain the load bearing aspects of the interface between the main lattice structure and the external shell.

As a practical example in the aerospace field, the system may be tasked to design a turbine blade having a lightweight internal lattice that meets strength and stiffness requirements, while including interconnected passages to promote laminar cooling. Further, this internal lattice must interface with the surface shell of the turbine blade to meet overall stiffness and superficial surface shear strength requirements for the blade.

### GEOMETRIC CONSTRAINTS: EXTERNAL SHELL THICKNESS

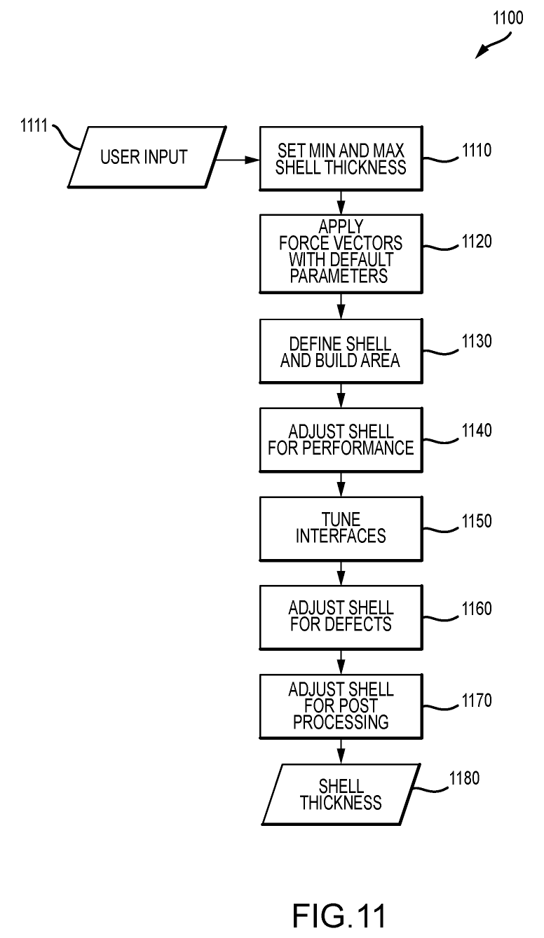

In some embodiments, the disclosed structural design process includes the establishment of an external shell thickness. With reference to FIG. 11 is depicted a flow chart 1100 showing an exemplary process for establishing an outer shell thickness for a structure as used in embodiments of the disclosed invention. At block 1110 the application first sets a minimum shell thickness, which requires the structure to have a shell with at least the minimum thickness surrounding the interior lattice. The application sets the minimum shell thickness to define the largest volume of the structure that could be filled with a lattice. The fillable volume of the structure is generally only slightly smaller than the outer shape of the structure. The minimum shell thickness may be set to zero in areas where a flat surface of the shape coincides with a flat side of a voxel fill zone. The application may also set a maximum shell thickness, which is set based on the size of the structure. An upper limit is reached where the shell thickness would result in a solid structure, meaning the AI model would return no solutions. At block 1111 an application user may also set a minimum or maximum shell thickness bounded by the geometric constraints of the shape.

At block 1120 the application applies individual force vectors to the external shell and fillable volume using default parameters including the baseline voxel shape and size. By modeling the effects of the forces on various parts of the structure, at block 1130 the application defines the shell thickness and the lattice build volume. The application defines the largest viable volume that can be filled with full-sized voxels of the shape and size of the baseline lattice. The shell thickness may require portions of the lattice to have a solid fill in portions of the shell that are too small to fit a complete voxel cell, or the shell thickness may be increased in areas that cannot accommodate a complete voxel cell.

Next, at block 1140 the shell thickness parameter may be adjusted to improve structural performance by tuning the shell-to-lattice interface. Such process includes the use of an iterative FEA analysis of forces exerted on the external shell and internal lattice that is populated in the build volume with the baseline lattice. The application then performs the FEA on the build area and determines structural solutions through an AI model. Through such checks, the application may identify issues with the default shell thickness, interconnections between the shell and the lattice, or with the lattice build. The AI model may indicate that a thicker shell would improve a performance characteristic of the structure, e.g., minimize stress or strain on a zone, dampen natural frequency propagation, improve thermal transfer characteristics, account for cyclic loading, etc. The AI model may also divide the build volume into smaller zones that are populated with lattice separately depending on the forces placed on the structure in the area of the respective zones. In some embodiments, the application is configured to pack partial Svoxels e.g., 1/2 of a cell, 1/3, 1/4, etc., or voxels with a smaller cell size into areas adjacent to a structure’s external shell.

At block 1150 FEA analysis may also indicate the need to adjust external shell thickness to allow for smaller voxels or partial Svoxels to be packed adjacent to the shell. Use of partial Svoxels or smaller voxels at the interface between the shell and lattice structure improves the transition to lattice comprised of whole voxels. In such cases, the shell thickness may be increased in an area to accommodate a transition layer of smaller voxels, or conversely, the shell thickness may be decreased to allow for an additional row of partial voxels. The shape of the external shell and the location and orientation of the underlying build area will determine what changes are appropriate. The application may use variations in the external shell thickness or lattice structure to improve the interface. Shell-to-lattice tuning improves structural efficiency by creating combined shapes where the stress concentrations caused by the shell are accounted for in the interface with the underlying lattice.

At block 1160 shell thickness may also be adjusted to reduce manufacturing defects and at block 1170 to account for post-build processing. For example, in cases where the shell comprises a flat solid layer on the top of a lattice zone, the application may increase shell thickness to prevent lattice fracturing caused by peel forces where the structure interacts with the printer bed. The shell thickness also may be altered to allow for post-build modification. For example, the shell thickness may be increased to provide volume that can be machined away to the structure’s dimensionality, or to allow conventional treatments to create a specified surface finish on the final product. The external shell may also be modified to include fiducials to allow the printed part to be fixed in a conventional machining center and to facilitate machine alignment with the printed geometry. At block 1180, with the various adjustments complete, a candidate structure is generated with a set external shell thickness.

### GEOMETRIC CONSTRAINTS: INTERNAL LATTICE STRUCTURE

In some embodiments, the system accounts for the geometry of the internal voxelated structure. An initial task for addressing such a geometric constraint is selecting a baseline lattice to interpolate across the structure, as is discussed in more detail above in reference to FIG. 1. A filtering function is performed to map the volume to be filled and then select the voxel shapes and sizes that will fit within the volume. Voxel shapes are ranked by performance for each type of physics constraint, and the highest ranked cell types that fit within the volume are used first. Manufacturability is considered by ranking the voxels according to suitability or ease of printing for the printer to be used and the material selected for the structure. Voxels are also ranked according to simplicity, with simple or well-characterized shapes ranked highest and more complicated or less-characterized shapes ranked lower. Alternatively, the user may select the starting set of voxels or provide the user’s own selected ranking of available voxel shapes.

Once a baseline lattice is selected and populated in a zone, the application determines how lattice elements within the zone interface to provide continuous stress-strain distribution, electrical conductivity, thermal conductivity, vibration control, accounting for cyclic loading (fatigue), or transmission of other physical interaction. To create a viable design, the application must generate a predictable interface among individual elements of the Svoxels that enables the, e.g., loading of a first Svoxel to be communicated to a second voxel, loading of a first Svoxel layer to be communicated to a second voxel layer, loading of a first lattice to be communicated to a second lattice, etc. With further reference to FIG. 6, for example, a solid connecting layer 620, 621 may be placed between voxel layers 610, 611, 612 to achieve required lattice element connectivity. Such layers will typically be at least as thick as the beam thickness of the smaller voxel layer at the interface.

Alignment of one Svoxel layer to the next must be accurate enough to transfer 80% to 100% of the force loading between mated beams. Alignment of the Svoxel beams from one layer to the adjacent layer depends on a number of factors, including the geometry of the voxel shape, the size of the vertices themselves, the loading of the structure or the edge conditions of the cell. The goal for proper alignment is to achieve between 50% and 100% mated cells across a given interface, e.g. , assuming one side of the interface has 100 cells, and the other side has 200 cells, the goal would be 50 to 100 mated cells. For overlap mating, the target may be 80% to 100% mated cells. In cases where the Svoxel face is coincident with a flat face of the structure, then non-mated Svoxels can be up to 25% of the total.

### INTERNAL LATTICE STRUCTURE: NEURAL NETWORK MODELING

In some embodiments, the system uses neural network modeling to ensure lattice-to-lattice interconnections. Using a neural network, the application may use 3-D data to model the new voxel shape. When reading in 3-D data, AI models need a large number of data points, which makes the data and model unwieldy. Additionally, the model needs training data for each voxel shape that will be modeled, and all data for each shape needs to be of the same input dimensions. As a result, the trained AI model typically will be specific to a single voxel shape, which is scalable to other sizes. Because of this, adapting an AI model trained on a first shape to design structures having a second voxel shape is a non-trivial task, since the model would require training on 3-D data specific to the second shape to produce valid outputs. In this context, stretching a voxel shape in a single dimension creates a new voxel shape, since the angles of the beam interactions will be altered, requiring different calculations to characterize the performance. Because the typical AI model can provide valid outputs for scaled versions of a single shape, scaling a voxel shape to generate a candidate design becomes more efficient than developing a new voxel shape. While single-shape AI models are typical, in some embodiments, training data for multiple voxel shapes may be used to train an AI model, which may then be used to design structures using the trained shapes.

As an example of the use of scaling to design a structure, a lattice shape may have a set of beam structures that are either uniform or asymmetric. The load bearing capacity of a cell of the lattice shape is based on the strength of the set of beam structures. The set of beam structures in the cell is proportionate when scaled, so that the characteristic set of beam structures is present in a scaled cell. The load bearing capacity of the scaled cell may be proportionate to the original cell or may increase or decrease according to a scaling factor.

Assume a second AI model is trained on outcomes from a first AI model that was trained on 3-D data, as described above. The second AI model would be trained on the same shape that the first AI model was trained for, as well as the output designs the first model generated. Not only would the second AI model use the same voxel shape as the first model but would also apply the same techniques as the first model when generating candidate structures. For example, the second model would follow the same incrementing rules as the first model, transition layers would operate similarly, as would the beam thickness, and lattice-to lattice interfaces. As a result, the lattice-to-lattice interconnections are ensured across similarly trained AI models for a given lattice shape.

### INTERNAL LATTICE STRUCTURE: OVERLAPPING

In some embodiments, the system uses overlapping structures to ensure lattice-to-lattice interconnection. When using overlapping structures, a first cell and a second cell are overlapped to create a predictable interface. In some cases, the two cells do not actually overlap, but have a mating interface which may vary depending on whether one cell intersects another at an outer surface or somewhere within the cell. The mating interface may also vary for instances when a cell intersects external shell geometry. Lattice overlaps may be used both on the horizontal interfaces and the vertical interfaces between adjacent cells to enable the communication of forces in all three coordinate axes.

An overlap zone may be defined as a set distance, or a set percentage of a cell when the cell is scaled. Overlap zones between Svoxels or cells is a result of geometric collisions and must be modeled. To model such collisions, the application generates a two-dimensional wireframe that connects all the intersection points together with beams. The beams are then thickened about the beam axis, and locations where multiple beams intersect becomes the overlap zone. Alternatively, a voxel shape may include a perimeter wall to facilitate connectivity from one cell to another, and to mitigate the need to have strict continuity of beams from one cell to the next. For such cell shapes with a perimeter wall, it is sufficient to have corner alignment from cell-to-cell to ensure adequate beam continuity.

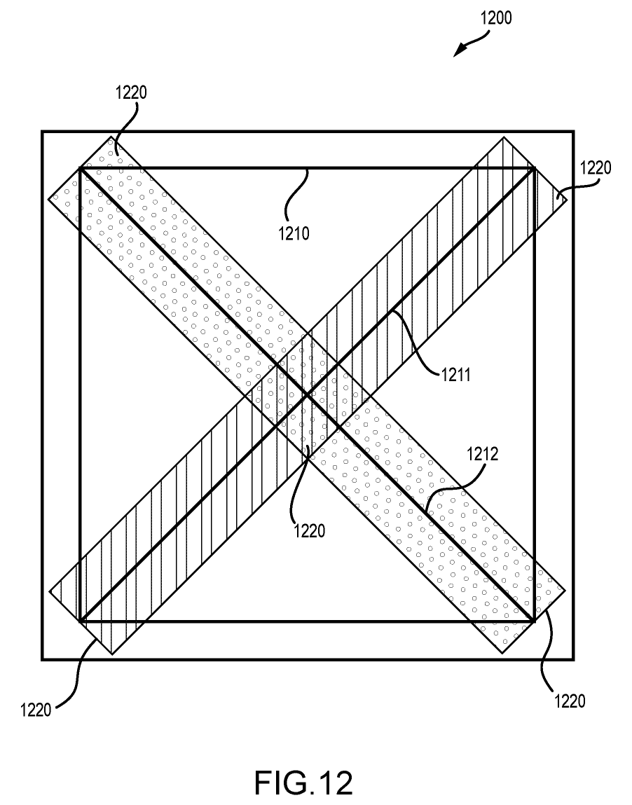

With reference to FIG. 12 is depicted an exemplary design process 1200 that defines internal overlap zones of a voxel shape. To determine the overlap zones for a voxel shape, first the shape is modeled in 2-D by generating the perimeter shape 1210 and the center lines 1211, 1212. Then, the center lines are thickened about the beam axis to the specified beam thickness. Areas that overlap with the perimeter shape are identified as overlap zones 1220. The overlap zones are then trimmed away to render the cell shape.

When designing overlap zones, inter-voxel and intra-voxel intersections may vary. The overlap zone for an intersection of cells in the interior of a cell may the same as the overlap zone for a perimeter-to-perimeter interface. However, this is not required. In some cases, the interface between voxels carries more structural load than within the voxel, since incomplete external interfaces may be present. In such cases, the voxel-to-voxel overlap may be slightly more than the intra-voxel overlap. This would produce a reduced overlap zone at the juncture of each lattice element to the next with the overlap zone between the calls being slightly larger. For example, Svoxels with a 20 mm cell size may be arranged along an axis with a spacing between each cell of 19 mm. Such a spacing pattern would create 0.5 mm of overlap on either side of each cell to ensure proper intersection with the adjacent cells. The overlap zones between cells and within cells are measurable in the printed structure, allowing the lattice shape and the element layout to be characterized and their performance evaluated.

In some embodiments, Svoxels are created by removing material from a solid, rather than generating beams that need to intersect precisely. Using a subtractive process ensures that there are no voids between cells. The network of the individual cells provides a framework to determine what material needs to be removed from the solid to create the voxelated structure.

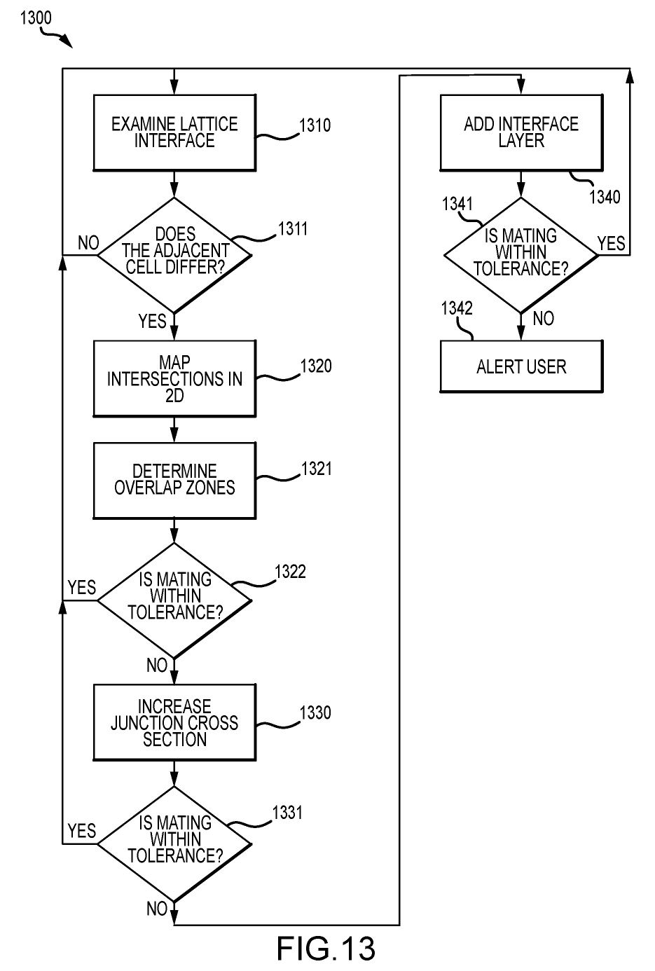

With reference to FIG. 13 is depicted a flow chart 1300 showing an exemplary process for aligning lattice elements to ensure transmission of forces between elements of a lattice structure. The application performs frequent checks to ensure proper mating from cell to cell, from lattice layer to lattice layer, and from lattice to the outer shell of the structure. As part of such checks, the application examines interfaces 1310 to determine if there is a change or variance in voxel shape, cell size, beam thickness, or a transition from a lattice structure to a mating interface or shell wall. At block 1311, if the cell or layer is mating with another layer or cell of the same lattice shape, cell size, and beam thickness, the AI model is already configured to ensure proper mating among lattice elements, however, if any of these criteria differ, a transition analysis is required. Interfaces between different lattice shapes, such as a BCC to FCC interface, or a BCC (or FCC) to fluorite interface are the most difficult.

To execute such further checks, the application renders the intersecting lattice elements in two-dimensional wire frame and maps the intersections of the elements 1320. Then, any beam elements are expanded from their respective axes to the beam thickness and overlap zones at the intersections are determined 1321. At block 1322, the application determines if the intersection is free of voids and discontinuities and checks that beam-to-beam mating is sufficient for transmission of a physics constraint, e.g., force, stress or strain. For example, the application may use a minimum mating percentage of 75%, or ideally 80% to 120% of beams will be properly mated. In the case of a 120% mating percentage, an adjacent lattice may have more beams per cell, requiring a mating percentage of greater than 100% to ensure proper force transmission. If the mating percentage is within tolerance and there are no voids or discontinuities, the application will proceed to check the next interface.

However, if there are voids or discontinuities or an out of tolerance mating percentage, the application may try to increase the cross section of the nodes between (or among) intersecting beams, or at locations where a beam intersects a surface 1330. Beam thickness may be increased at a node by a factor of the original cross section, e.g., 1.5 times (X), 2X, 2.5X, or other suitable amount of increase. At block 1331, the application again checks for voids, discontinuities, and mating percentages. If the interface is still deficient, the application adds a solid interface layer between the two interfacing elements 1340. The transition layer may be, e.g., at least 75% as thick as the thinnest beam in the interface, and at least thick enough to ensure a 75% mating percentage of beams in the interface. At block 1341, the application again checks that the interface is within mating tolerances and free of voids or discontinuities. If still deficient, the application may alert the user of continued interface difficulties 1342.

### INTERNAL LATTICE STRUCTURE: VOXEL PACKING

In some embodiments, the system determines the internal lattice structure of a candidate design by evaluating different potential voxel packing configurations. The various configurations are each analyzed to identify those configurations that best balance the reduced voxelated volume with the specified structural performance requirements, e.g., strength, stiffness, natural frequency, thermal conductivity, cyclic loading, etc., of the lattice.

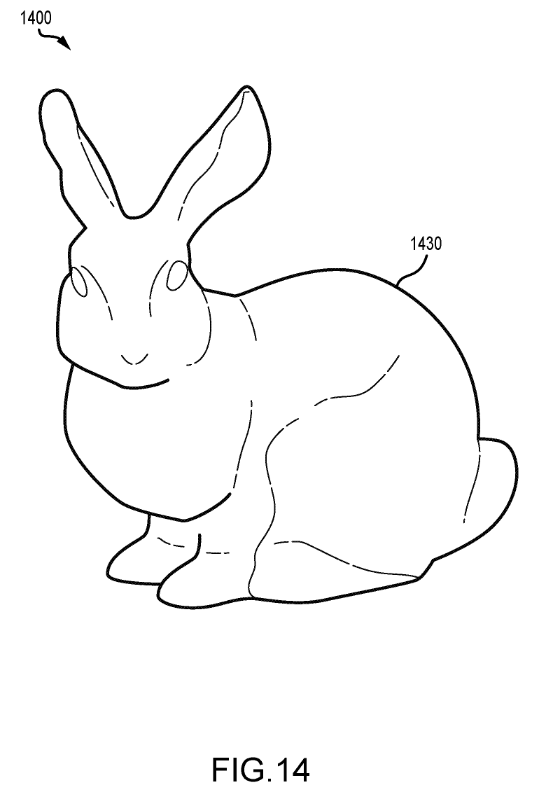

A structure’s overall volume or build space is defined by the external shell. With reference to FIG. 14 is a top perspective view of an exemplary structure 1400 to be rendered. The external shell 1430 represents the shape of the structure to be partially filled with Svoxels. When developing a candidate design, the application initially packs the Svoxels into the shell using only complete voxels. With reference to FIG. 15A is a top perspective view of the structure 1510 rendered with 100% of the internal volume filled with complete voxels 1511 of the same cell size and voxel shape. As a contrast, with reference to FIG. 15B is a top perspective view of the structure 1520 rendered with only a portion of the internal volume filled with complete voxels 1521 of the same size and shape. Areas that cannot fit a complete voxel 1530 are left solid to mate the shell to the lattice while limiting concentrations of stress at the interface. To improve packing density of the Svoxels, the application may render another candidate design of the structure by adjusting the size of the Svoxels relative to the shape of the shell. Voxel size may be kept uniform across the entire lattice, or multiple Svoxel sizes may be used to improve packing density for a shape.

When different sized Svoxels are used within the same lattice, the application will attempt to mate the intersections of the beams with the objective of reaching a specified minimum percentage of mated interconnections. Means to achieve the required interconnection levels may include, aligning the beams at the interface between Svoxel sizes, or the use of overlap techniques as discussed above, e.g., increasing the cross-section size of beams at the interface, by including a perimeter frame around each Svoxel, or other suitable technique. When using a perimeter frame for a voxel, the frame would ideally have the same size cross-section as the voxel, but in some cases, the frame cross section may range from 80% to 120% of the voxel beam cross section. Such a size range for the frame cross section will tend to maximize the distribution of stress or other interaction from one voxel to the next.

In some embodiments, the application sets a minimum shell thickness, which requires the structure to have a shell with at least the minimum thickness surrounding the interior lattice. The minimum thickness may require areas of the structure to have a solid fill in areas that are too small to fit a complete voxel shape. The minimum shell thickness may be set to zero in areas where a flat surface of the shape coincides with a flat side of the voxel shape. The application may also set a maximum shell thickness, which is set based on the size of the structure. An upper limit is reached where the shell thickness would result in a solid structure, meaning the AI model would return no solutions.

Some embodiments of the application use finite element analysis to identify zones within the structure that are subject to different magnitudes of physical interaction or that have different physics constraints from other zones. For example, a zone may be a designated volume that is exposed to a higher level of stress than adjacent volumes, or a zone may be designated that requires a higher stiffness capability than other volumes in the structure. Each zone is packed with Svoxels separately, so that the application may choose an appropriate beam thicknesses, voxel shape, and cell size for the physics constraints required for the zone.

The designation of such zones has implications for packing configurations and voxel sizes used by the application to fill the volume of the entire structure. Subdividing the structural volume into zones complicates the system’s design task, since each zone may require a different lattice structure, different AI models may be required to address different physics constraints, and transitions among the zones must be designed. The application may use different strategies to develop a voxel packing configuration for each zone. For example, the application may start with the centerline of a zone and build out the lattice structure to the zone perimeter, or the transition areas between zones may be designed and the remainder of the zone packed with cells from there.

As another example, if the application is tasked to fill an unknown volume, it may use the following exemplary process. First, the application chooses a voxel shape and places an Svoxel or cell of that shape in several locations inside the volume. With a list of locations having a cell, the application then creates an instance of the function defining the Svoxel at any point in space. Next, the application transforms all of space having an Svoxel to be within a first unit cell space: Xnew = Xoriginal - spacing * (Xoriginal/spacing). Where Xnew is the new position in 3-D space, Xoriginal is the original evaluation point in 3-D space, and spacing is the distance between cells. This transformation allows the application to model and evaluate the signed distance field (SDF) for an infinite number of cells in the same calculation time it takes to evaluate the SDF for a single cell. The technique can be applied to uniform or non-uniform cell sizes or beam thicknesses. Next, the application creates a list of boxes and determines where structure is required, i.e., the application builds a lattice to fill the entire volume, then only keeps the lattice in locations where structure is required. Finally, the application dynamically merges all the boxes that are connected to one another, so that a single cell may be evaluated instead of two adjacent boxes. For example, to evaluate a cube of 2 X 2 X 2 adjacent cells, it would normally require 8 evaluations, but by use of the dynamic merging technique, the solution can be derived from evaluating only a single cell.

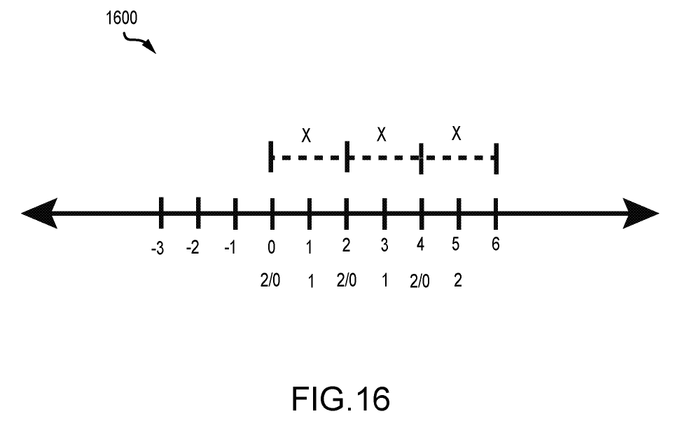

With reference to FIG. 16, is depicted an exemplary scale 1600 showing the process of filling a 2 X 2 X 2 volume. Substituting the relevant numbers into the transformation equation above, provides as follows: 0 = 4 – 2 * (4/2). As depicted, all numbers on the number line are remapped by the transformation equation, so that the numbers 1, 3, and 5 all get mapped to 1, and the numbers 0, 2, and 4 all get mapped to 2 or zero. In this mapped domain, 2 and zero are equivalent.

Once a zone is populated with a lattice, the application also accounts for a zone-packing configuration. In other words, the zones may be aligned, resized, or reshaped to achieve an optimal packing configuration for the overall structural volume. Zone size and shape may also be adjusted to improve the packing configuration inside each zone, to improve zone-to-zone transition, or other relevant consideration.

The application may align, resize, or reshape zones within the structure to maximize density of the voxels within each zone, or within the overall structure. Similar to the designation of zones based on loading, to divide the build space into zones based on voxel density, the application identifies volumes that are oriented and sized within the build space to increase voxel density. The size of the Svoxels from one zone to the next may be varied based on the space available. Zone designation based on density may remain secondary to zone definition based on the performance characteristics of the structure. For example, zones may be designated based on loading, and then other zones, or subzones, designated according to density. Alternatively, zones may be designated according to loading, then voxel packing accomplished to support loading primary and then packed to maximize density secondarily. Likewise, within each zone, cell size, voxel shape, and beam size may first be defined by the loading considerations, and secondarily to maximize voxel density.

The application uses various strategies to identify and designate zones for voxel packing. Such zones may be determined by the shell thickness, build space, and cell size. First, a ML optimization process defines the build space, i.e., the maximum volume within the shell to be filled with a lattice structure. With the shell thickness and build space defined, the AI model produces multiple candidate voxelizations, then designs that satisfy the build specifications are selected from among the candidates. The AI model performs independent solution processes on each potential combination. For example, assume three lattice shapes and three cell sizes, e.g., 10 mm, 20 mm, and 30 mm. The AI model will run 9 iterations, one with each combination of cell size and lattice shape, which will produce a maximum of 9 solutions. The application may also parameterize the cell size as a model input, so theoretically the application may interpolate to other cell sizes, even if the model database does not include explicit data for these other cell sizes. For example, if practical testing were only completed for 20 mm and 30 mm cells, the AI model may also create a set of solutions using 25 mm cells.

The application may conduct an iterative process to identify subdivisions of a zone, and then separately pack the subdivisions to improve voxel density. Such a process includes running FEA on AI model results both to check whether the AI model results are converging on a solution, and to adjust the cell size, voxel shape, and beam thickness to improve voxel density. For example, a voxelization process begins with running the AI model using default settings, such as 10 mm cell sizes with a single lattice shape to generate a candidate design. The application runs an FEA on the candidate and uses the FEA result to assess whether a larger or a smaller cell size is needed. The application then runs the AI model on the lattice shape with a new cell size to generate a second-generation candidate design. The application runs an FEA of the second-generation candidate, and so on until both the AI model and the FEA analysis converge on a candidate design. Similarly, the application may use FEA as an assessment tool for the AI model, e.g., the application uses FEA to assess how much the candidate design diverges from a theoretical value for the design. The application may also use FEA examine a candidate design to identify sub-volumes that have performance requirements that diverge over a specified threshold compared to adjacent sub-volumes. The sub-volume with the different performance requirements may then be designated as a zone and the lattice structure may be designed separately for that zone.

The application uses the following exemplary method to define zones to be packed with Svoxels. The AI model begins with a set of default options or settings and then iterates to develop a solution. Use of default settings minimizes the requirement for pre-analysis and results in the selection and build out of the lattice shape using a single voxel type that is selected based on a worst-case stress concentration area of the entire shape. In other words, the ML model selects a default shape and conducts an initial build having one zone with a single voxel shape being packed throughout the zone based on the location of the highest stress concentration area. Next, the application subdivides the initial voxel packing area into subzones based on the forces placed on each zone. The resultant forces are fed into a preliminary FEA which identifies localized areas within the initial voxel packing zone that have higher force concentrations. The application defines the main bulk of the interior as a first zone, and locations experiencing high force concentrations are defined as separate zones.

In some embodiments, the shell thickness parameter may be adjusted based on outputs of an AI model. The application may use an iterative FEA process to adjust the base parameters of the build area. The application defines an initial build area, i.e., the volume that will be filled with a lattice structure, based on default parameters. The application then runs an FEA on the build area, which may identify a problem with the default shell thickness, build area, interconnections between the shell and the lattice, or lattice shape and cell size. FEA may indicate parameters that should be altered to minimize the problematic characteristics. For example, FEA may indicate that a thicker shell would minimize stress or strain on a sub-volume, could dampen natural frequency propagation, improve thermal transfer characteristics, account for cyclic loading, or improve any other performance characteristic.

In some embodiments, the lattice structure is designed to account for an externally applied resultant force. The application determines the overall resultant force placed on the structure based on the combination of all applied forces and their location. The resultant force vector is then used to determine the structure’s ideal rotational position, which in turn is used to orient the build space and lattices in Cartesian coordinates relative to the new structure orientation.

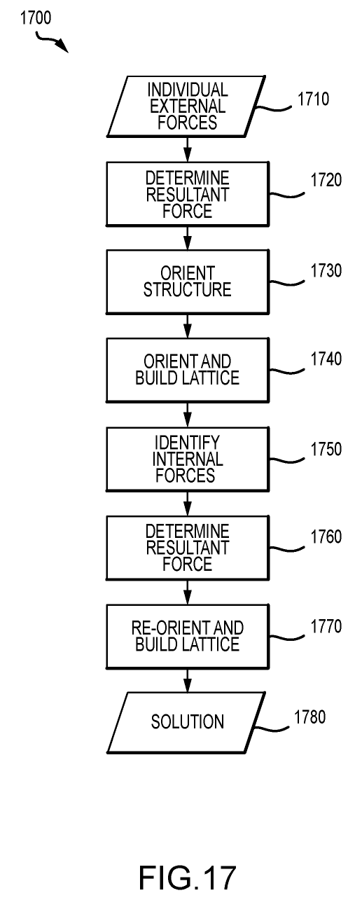

With reference to FIG. 17 is depicted a flow chart 1700 showing an exemplary procedure to resolve the composite external forces and align the lattice to this composite external force. At block 1710, a user inputs individual external forces that are exerted on the structure into the application. The application then sums the external forces into a resultant force and reaction couple at block 1720. At block 1730, the structure to be designed in the AI model is then aligned to this resultant force so that at block 1740 the lattice may be organized and built orthogonally to the resultant force vector. Such orthogonal lattice orientation is the default setting, but the default alignment may be altered based on other considerations, such as the structure geometry, or stress/strain concentrations resulting from internal features. For example, if the internal geometry has features that cause concentrated stress or strain that results in deformations of the lattice, then the lattice orientation may be adjusted to align the higher strength properties of the lattice to account for internal forces. In such cases, at block 1750 the application identifies the internal forces affecting a lattice. Once identified, at block 1760 the internal forces are resolved into an internal resultant force. Then at block 1770 the lattice orientation is adjusted to better align lattice structures to the internal composite force and the lattice is rebuilt with the new orientation. The application then outputs the candidate design at block 1780. By starting with a default lattice alignment that is orthogonal to the composite external force and secondarily adjusting the alignment to account for internal forces (if necessary), the application streamlines and accelerates the analysis and convergence of the AI model toward a solution.

A user may also play a role in setting the alignment of the lattice. For example, the user may define the external force vector(s) acting on the structure. From there, the application uses an AI model to map the resultant strain throughout the structure and resolves the user input forces to a resultant force vector. Use of the resultant force vector simplifies the analysis and mathematics used to determine solutions of the lattice. The model then aligns the lattice orthogonally to the resultant external force vector to maximize the capabilities of the lattice relative to the resultant external force.

In some embodiments, the lattice structure is designed to account for internal forces or stresses. Depending on the magnitude and direction of internal forces, the application may alter cell size or beam thickness in a sub-volume, or in some cases include solid cells, to account for internal stresses.

In some embodiments, the lattice structure is designed to account for manufacturability constraints. For example, when using additive manufacturing to generate a design, the design occasionally must include open areas to allow the removal of support structures or other waste material. For post-print machining, some shapes require access points to allow cutter tools to access the open areas. These structures will require an access channel that must be accessible all the way through the lattice, requiring geometry that includes aligned access points. Similarly, some structures manufactured on a 3-D printer require an interconnected lateral access channel to allow a removal tool to access and remove waste material.

In some embodiments, the application determines a packing configuration for Svoxels having multiple cell sizes. First, the application attempts to align the vertices of voxels having a first size with the vertices of adjacent voxels having a second size. Such alignment facilitates load transfer across size interfaces and through the structure, while minimizing the stress or strain concentrations at the interfaces. For cases in which vertices cannot be aligned, the application may modify the shape of voxels at the interface either through use of transitional elements, through use of external frames added to the standard voxel shapes, or other overlap techniques.

A practical example of lattice alignment and zone designation in the field of machine tool manufacture is the design of an off-center cam lobe and gear for a restrike press. Assume the restrike press includes a flywheel that is connected to an actuator via a large diameter gear coupled with an off-center cam lobe for moving the actuator up and down. The cam lobe has a long stroke with an abrupt high force compression at top dead center. The gear experiences a lateral load, and an axle supports the gear load and off-center loading. The cam and the gear are preferably high strength, with the cam lobe designed to limit strain and deformation at the top dead center position.

The high stress zones would include the perimeter of the main axle support, the connection area between the gear teeth and the hub, and the off-center lobe. A critical high strain area that would impact the overall stroke of the lobe at top dead center is located where the offset aspect connects to the hub of the gear. This zone would experience both high shear stress, and the resulting deformations would affect both the direction of the press force and the stroke magnitude. Each of these 5 zones are then packed with Svoxels separately. Each of the areas would have its own lattice alignment, which may be the main alignment of the initial voxel packing zone, or each subdivision may have its lattice adjusted to account for the internal force orientations experienced in that area. Each of these areas may have the same cell size and voxel shape, or they may be packed with Svoxels of a different size or shape suited to the loading of the area.

If different Svoxels are used in each zone, the application would populate each zone with the size and shape of the voxels most likely to function under the loading applied. The application would begin with this initial voxelization and then iterate through crossbeam thicknesses to determine the range of solutions. With the range of solutions in hand, the application would then re-pack each zone using other voxel sizes, shapes, and beam sizes to establish a set of viable solutions. With a solution set for all of the zones, the application then turns to transitional areas to complete the structure. When adjacent zones have unaligned lattices, the application may insert a transitional layer between the zones. The layer would have a thickness range based on the lattice structure of the adjacent zones, e.g., a maximum thickness set by the smallest voxel size of the two adjacent zones, and a minimum thickness set by the smallest beam thickness of the two adjacent zones. Other transitional layers may also be used, such as a layer wherein the lattice structures of the adjacent zones are altered to align the beams to ensure proper interconnection.

The application’s use of FEA to develop a lattice packing configuration results in a tendency for the application to select undersized cells or to overpack a zone with too many cells. Such tendencies are caused by FEA mesh artifacts which the AI model misinterprets as additional internal stresses within the lattice. The mesh artifacts arise from the use of shortcuts to reduce FEA solve time. The shortcuts are 1) an FEA mesh is defined as 0.0005 to 0.0500 of the largest externally facing feature of the relevant zone before the packing configuration is developed, and 2) a volume stress density value is used to determine the minimum strength of an individual cell. These shortcuts cause FEA analysis to overestimate cell strength requirements for zones with an irregular geometry interface to the shell or another zone. The overestimation is 50% or greater than the minimum size of the Svoxel. For more accurate packing configurations, the application removes an overestimation value resulting from FEA mech effects before selecting a minimum cell size.

The application may also insert negative spaces, or open lattices in areas that do not require strength or structure to minimize build complexity and time. For example, if the stress loading in a zone were below the minimum delivered by a minimum voxel lattice, an intentional negative space could be defined as a void, and the application would not populate the zone with a lattice.

In some embodiments, the application is configured to pack partial Svoxels e.g., 1/2 of a cell, 1/3, 1/4, etc., or voxels with a smaller cell size into areas adjacent to a structure’s external shell. The external shell thickness may be varied to allow the smaller voxels or partial Svoxels to be packed adjacent to the shell. Partial Svoxels may include an external frame to facilitate load transfer from the external shell to the partial Svoxels, and in turn to the main body voxels, i.e., whole voxels. Partial Svoxels or smaller voxels allow the external shell to interconnect with the adjacent whole voxel lattice more precisely than is possible with a direct interface between the shell and whole, full-sized voxels of the main lattice. Transitional voxels may be varied in a number of suitable ways, such as by using a partial Svoxel, varying the beam length of the main voxel shape, or varying the voxel shape. Transitional voxels are varied to improve the interface between the shell and main lattice, to improve structural integrity, to improve load bearing capability, or other similar goals.

### INTERNAL LATTICE STRUCTURE: MACRO VERSUS MICRO ELEMENTS

To accurately model voxel performance, the application must account for the size of voxel components relative to at least two size thresholds. On the macro side, there is a beam thickness at which the beam equations of a Svoxel begin to impact the overall performance of the lattice. Similarly, on the micro side, there is a beam thickness below which voxel performance must be modeled by a different physical model than is used for larger beam sizes. When using smaller size beam thicknesses, an AI model must be trained on small beam voxel data. Because of these size-related performance model variations, the application may identify, or a user may provide, a beam thickness threshold at which the application switches from evaluating micro elements to macro elements. Similarly, the application may use a threshold at which both macro and micro elements must be included in the training dataset to properly characterize performance. A macro element may be, for example, a cell larger than 1 meter (m) in a single direction, while a micro element is a cell that is smaller than 1 µm in a direction. The AI model may then use the combined dataset to determine whether a small beam or standard beam voxel is appropriate for the design task.

When designing a lattice adjacent to the external shell, the amount of physical space available affects the choice of smaller cell size over larger cell size. Multiple smaller Svoxels can provide variable levels of flexibility while still supplying enough strength to support the static load from the shell, so the AI model will tend to iterate around small cell sizes and simple voxel shapes that support the loading conditions while also providing the required flexibility. In this way, at locations with higher localized stress, the AI model may construct rows of smaller Svoxels and combine them either in parallel or in series to manage the external forces they must support.

Stiffness or flexibility is not proportional to cell size or beam cross section, rather the density of voxels in a given volume is the main determinant of lattice stiffness. If a lattice has relatively more cells arranged in the same plane and oriented perpendicular to the force vector, the lattice will be stiffer. Similarly, if a lattice has relatively more cells along the loading axis, it will be stronger.

### INTERNAL LATTICE STRUCTURE: THREE STANDARD LATTICE STRUCTURES

In some embodiments, the system is configured to work with three key lattice shapes. Each of the standard lattice shapes have benefits and limitations relative to each other.

The first standard lattice shape is a face-centered cube (FCC). With further reference to FIG. 3 is depicted an exemplary FCC shape 300. The FCC lattice is lightweight, has a low fill percentage, has beams oriented to the cardinal axes 310, provides full beam contact with the perimeters of the cell, and meshes cleanly with adjacent flat surfaces. Further, the FCC shape has terminating beams that are not cantilevers, meaning they intersect with at least one other terminating beam in the lattice, and hence have good edge and corner stiffness. The limitations of the FCC include edge beams 311 that are bisected versions of the internal beams and consequently are much weaker than the internal beams. Additionally, it is difficult to remove waste material from the internal empty space. Further, FCC shapes have flat overhangs that are unprintable with certain printing methods.

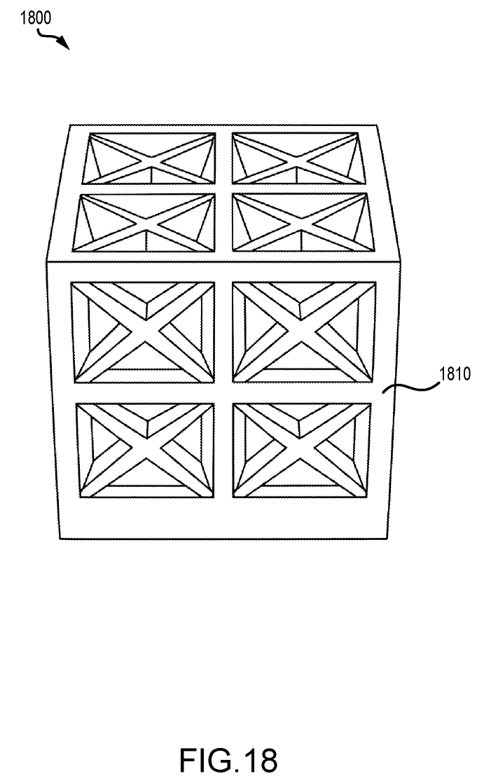

With reference to FIG. 18, an FCC shape 1800 may include a perimeter frame 1810 to improve interconnection to adjacent voxels and ensure proper load sharing voxel-to-voxel. Perimeter frames are particularly useful when a lattice includes voxels of different sizes, since the vertices of the beams will not intersect at common corners. Perimeter frames are also useful when the beam thickness is small and approaches the error limit of the printer. In such cases, the printer may be prone to error from one cell to the next, resulting in inconsistent intersections at voxel corners.

The second standard lattice shape is the body centered cube (BCC). With further reference to FIG. 4, an exemplary BCC shape 400 is depicted. This type of lattice is stronger than FCC lattices, and it is easier to remove waste material from the printed shape. The BCC shape also lacks purely vertical beams, which removes some buckling concerns present with FCC shapes. BCC shapes are relatively easy to print in most processes. The limitations of BCC lattices include difficulty in aligning beams 410 from voxel-to-voxel, resulting in poor transmission of forces through the lattice. With further reference to FIG. 7 is depicted an exemplary BCC lattice 700 with perimeter frame support 710. As with the FCC shape, adding perimeter support to BCC lattices improves interconnection to adjacent voxels and ensures proper load sharing voxel-to-voxel.

The third standard lattice shape is fluorite. With further reference to FIG. 8 is depicted an exemplary fluorite lattice. Fluorite configurations provide exceptional strength but tend to be relatively brittle. It is also relatively difficult to remove waste materials when printing with dense powder materials. Fluorite has multiple beams 810 and nodes 811 that reduce the effect of any single defect within the cell. Limitations of fluorite include that the high number of beams and nodes means beams need to be small relative to the unit cell for the geometry to reliably resolve, i.e., there are fewer options for beam thicknesses before the cell becomes solid.

In some embodiments the system is configured to use variations on the three main lattice shapes. For example, with further reference to FIG. 9 is depicted an exemplary FCC shape 900 having thicker cross-sections at junctions 910 relative to the beam 920 thickness. Generally, any time a voxel shape includes beams and nodes, these may be varied to include an expanded area at beam junctions, wherein the expanded areas are thicker than the beam cross sections. Use of larger intersections improves the transmission of stress forces between voxels relative to a similar lattice shape with normal junctions. The amount of increase at junctions may be a factor of the beam thickness. Expanded joints provide relatively more benefits for voxels with a smaller beam thickness.

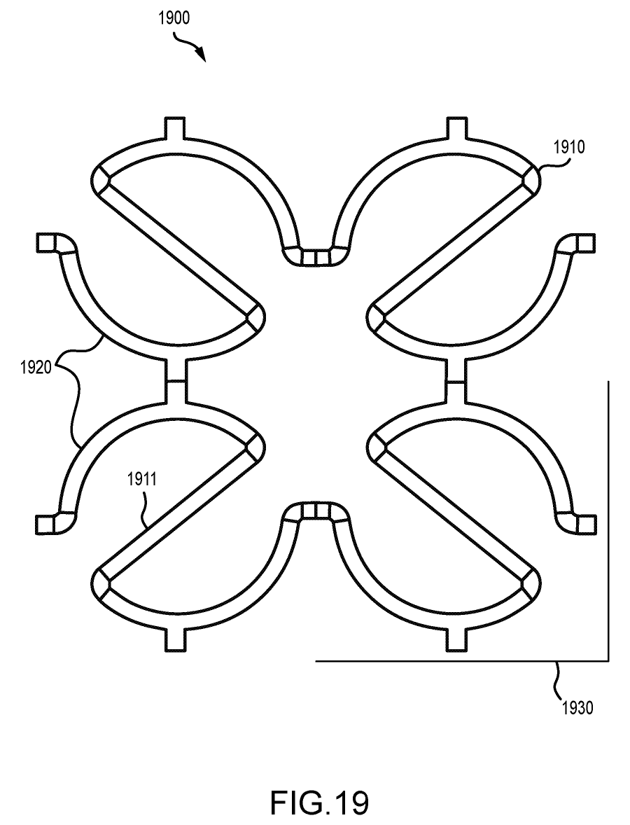

Some embodiments of the system are configured to use additional standard voxel shapes. With reference to FIG. 19 is depicted a diagram 1900 showing an exemplary process to define a new voxel shape. First, the new shape is broken down into its basic components, in this case arcs 1910 and rectangles 1911. The black arcs and lines 1920 denote the boundaries of these basic shapes. These arcs and lines are then used to evaluate and create the signed distance field. The signed distance field is defined by the orthogonal distance of a given point x to the boundary of a set Ω in a metric space, with the sign determined by whether x is in the interior or exterior of Ω. In this case, one corner 1830 was built first and then reflected and reflected again to create the 4 corners.

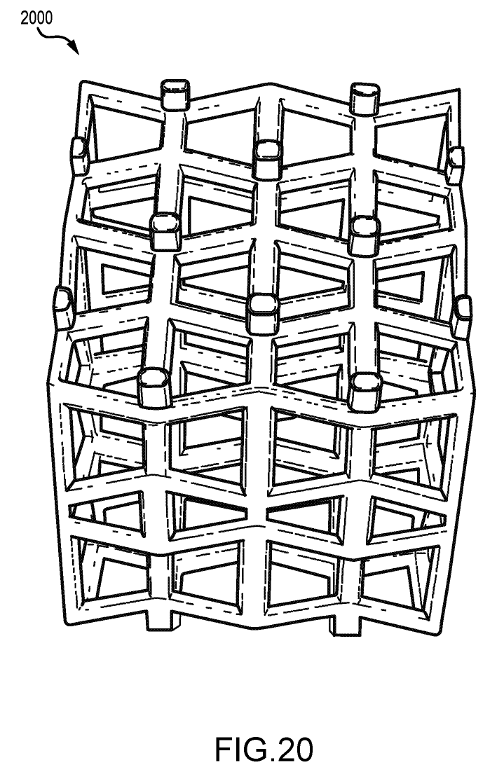

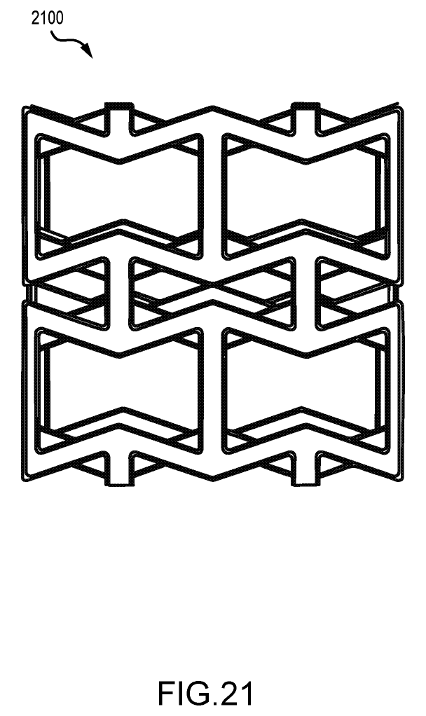

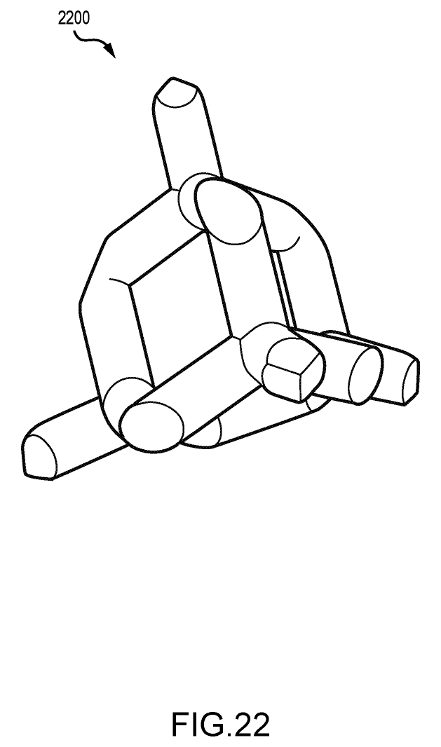

With reference to FIGS. 20, 21, and 22 are depicted exemplary second-generation standard voxel shapes 2000, 2100, 2200 that are used with the existing standard shapes. The system will benefit from having additional standard structures with a perimeter shape that provides a continuous interface between voxels with simple and precise beam continuity, among other advantages.

### INTERNAL LATTICE STRUCTURE: SCALED SIGNATURE LATTICES

In some embodiments, the application scales standard lattice shapes to fulfill the requirements of a structure. When a lattice is scaled, the application must estimate the performance of the lattice at the new larger or smaller scale. Such an estimation process would benefit greatly from the ability to extrapolate structural performance for a structure at a known scale to estimate the performance at a different scale. To do so, the application determines whether the performance of the scaled standard lattice is proportionate to the change in size, or whether the application must apply a scaling factor to estimate the performance of the structure at the new scale.

### INTERNAL LATTICE STRUCTURE: PAIRING DIFFERENT LATTICE TYPES

The interface between Svoxels being aligned and overlapped is a means to ensure consistent force transmission from one voxel to the next. For example, a first Svoxel has a first beam and a second Svoxel has a second beam, wherein the first beam extends toward the second beam at an interface. The beams are aligned and overlapped a given amount that is similar to the amount of overlap used to connect the internal beams of the Svoxels. Assuming several such beams meet at the intersection, at least 50% of the beams must be properly aligned and overlapped to ensure adequate force transmission.

In cases where different voxel shapes meet at an interface, there likely will be beams that have no counterpart in the adjacent Svoxel. To mate the two different Svoxels, the application may either eliminate the unmatched beams or add a continuous interface layer. The continuous interface may use a boundary constraint or a binding aspect that would enable the interface with adequate force continuity. In other cases, a transitional cell may have its beams scaled from one side to the other to change or tune structural properties for the interface.

Voxels within a single layer do not have to be homogenous. With further reference to FIG. 6, section beams 630, 631, 632 and cell sizes may change within a lattice layer. As another example, a single layer may include cells of different voxel shapes. For example, an FCC voxel shape may interface with a BCC voxel shape, in the same layer. However, Svoxels in a single layer must be tessellated, i.e., integer divisible. For example, one larger cell may be paired with two smaller cells or three smaller cells, but a larger cell cannot be paired with 1.5 smaller cells. In some cases, an interface layer may be used to facilitate force transmission across heterogenous cells. For example, beam cross sections may change thickness from a first cell to a second cell to ensure a good interface between the cells. Another limitation is that cell homogeneity may change in any single axis, but not in multiple axes. Multiple axis heterogeneity results in multiple discontinuities, and therefore poor force transmission.

### INTERNAL LATTICE STRUCTURE: JUNCTIONS

Junctions within the lattice beams may connect within a single cell or between cells. Overlap zones relative to internal junctures and external beam interfaces may be used with beams of the same or different lengths. A beam juncture or node is a combination of intersecting beams and therefore may have different shapes, e.g., a 3-D hexagon, a sphere, cube, or hourglass shape.

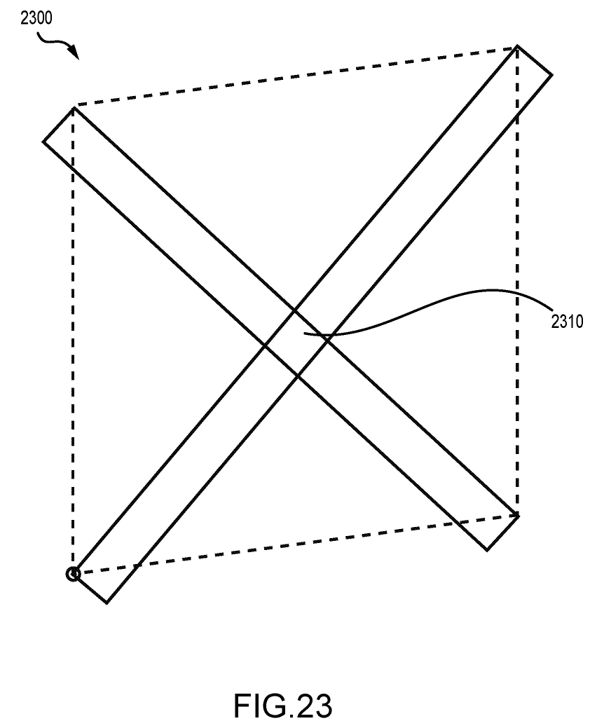

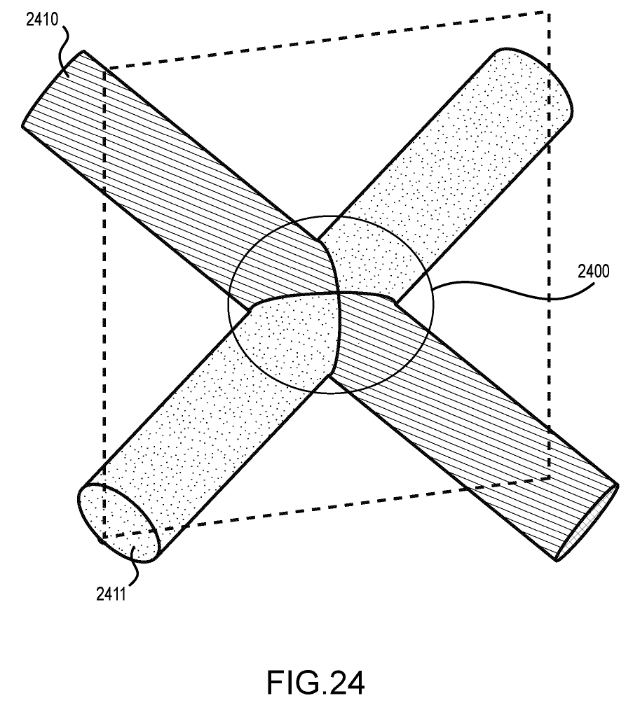

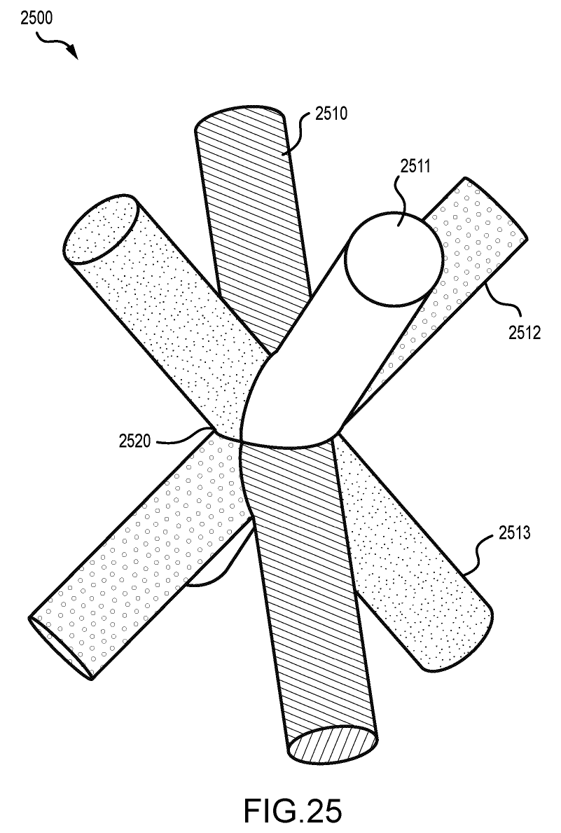

In some embodiments, the application creates external beam interfaces between cells as part of the AI modeling process for a structure. In some cases, the connecting beams will have enlarged cross sections at the interface to improve beam alignment, or to improve force transmission between cells. The application may develop external beam interfaces automatically or may invite user input with a system prompt. The AI model creates a candidate design through its normal process by selecting a cell size, developing an alignment and packing configuration, selecting a voxel shape, and selecting a beam thickness. With reference to FIG. 23 is depicted an exemplary initial stage 2300 in the creation of a voxel node 2310. Once the voxel beams and other structures are created, the area where two or more structural elements occupy the same volume becomes a junction or node. With reference to FIG. 24 is depicted an exemplary designation of a node 2400 created where two cylindrical beams 2410, 2411 intersect. Node creation works in a similar way for more complex intersections. With reference to FIG. 25 is depicted an exemplary designation of a node for a complex beam junction within a voxel shape 2500. As shown, four beams 2510, 2511, 2512, 2513 intersect at a node 2520.

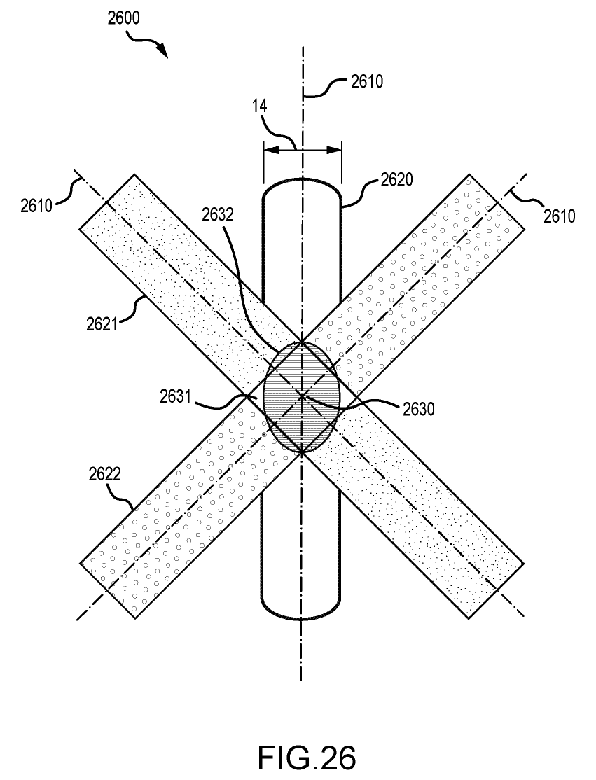

With reference to FIG. 26 is depicted an exemplary illustration 2600 of a process for designating an interior node within a cell for the lattice shape 2600 depicted in FIG. 25. The application first mathematically creates a zero-thickness skeleton comprised of skeleton beams 2610 that link points together in 3-D space. The linked points become a 3-D skeleton. The point at which all of the beams intersect becomes the node 2630. Solid cylinders, e.g., 2620, are constructed around each of the skeleton beams, using the beams as the axis of the cylinder, and using the beam thickness 14 as the diameter of the cylinder. The resulting intersection of the cylinders at the node 2630 creates the nodal geometry. For example, a first cylinder 2621 and a second cylinder 2622, as pictured, the cylinders are bisected and appear as rectangles, intersect orthogonally at the node, and create a square cross section 2631. In cases where beams intersect at an acute angle, the cross section will appear as an ellipse, e.g., 2632, where the minor axis is the beam thickness 14. There are no modifications to beam thickness about the node 2630. Overlapping areas from all of the intersecting cylinders are rendered as solid and create the node geometry. In cases where an internal beam does not have a corresponding mate on the other side of the node, the application must add intra-lattice transition elements to create a suitable junction with force transmission capability.

The use of straight-line beam shapes, e.g., beams with a rectangular cross section, provides an additional variable to adjust to fine-tune design performance. Namely, a beam with circular cross sections has only the radius to adjust, while a rectangular beam has a length and width to adjust. However, any time a cross section includes sharp angles, as are present with a rectangular cross section, stress and strain tends to concentrate at those locations. In addition, AI models use substantially more computing resources when solving for beams with rectangular cross sections, since the additional parameter requires the AI model to solve and optimize a higher dimensional function. When calculating nodes and intersections, using straight line beam shapes also slows down meshing and hence AI model solution speed. Therefore, the ideal configuration for improving AI model solution speed is to pair beams with circular cross sections with rounded nodes, as described herein.

For suitable interconnections between cells, the application uses scaling transition layer cells in a transition layer to create the interconnection, however, in some cases, the external shell does not allow for the use of complete cells near the lattice-shell interface. As a result, some cells may have partial discontinuities at the corners where the lattice interfaces with the external shell, e.g., a 1/2 or 3/4 corner interface with a small perpendicular. Such interfaces will have beam continuity but will not have full beam thickness at the interface and are characterized as a 50% or 25% interface mismatch.

### GEOMETRIC CONSTRAINTS: CUSTOMIZED GEOMETRIES

In some embodiments, another geometric constraint includes the use of customized geometries. Customized geometries may be used for situations having unique or specialized stiffness, strength, or other performance requirements. In such cases, multiple voxel shapes, cell sizes, and beam cross-sections within a single zone may be used to meet performance requirements and respond to geometric challenges. Similarly, empty or negative space in a lattice may be filled with secondary structures to improve performance.

For a practical example from the medical device field, assume the need to create a lightweight titanium hip replacement having the required strength to support a patient’s body weight. To design the structure, an initial step may be to define the area requiring voxelization by defining an overall voxel packing volume or build space and subdividing the build space according to stress or strain variations experienced within the structure. Such zones may be identified and defined during initial analysis of the structure. A user inputs overall structure geometry and external force vectors for the structure, then the application conducts an initial FEA screen. The FEA screen identifies, for example, two core zones to be filled with lattice structures based on identified stress concentrations and stain distortions. Initial FEA screening also identifies secondary zones that may be packed separately due to their volume or location within the outer shell to achieve the optimal voxel packing strategy for those secondary zones. The application may generate solutions having different voxel sizes or shapes within each zone. Zones may be packed with Svoxels of the same size and/or shape, or a zone may have Svoxels with a different sizes and/or shapes based on the requirements for each zone. For example, the AI model may generate solutions using smaller Svoxels in zones that are highly complex in shape, or that experience high or complex stress, strain, or deformation. Similarly, larger zones, zones with a regular shape, or zones without complex force interactions may use larger voxel sizes. The AI model then uses the forces applied to each zone to determine the required beam cross sections. The AI model defines one or more beam cross sections for each viable lattice shape and size based on the stress and strain results generated by the FEA screen.

As a result, multiple viable candidate designs may be generated for the hip implant. The AI model evaluates each shape separately and then evaluates a range of beam cross sections and beam lengths that meet the user-defined performance requirements. The application then filters the viable designs according to printability considerations. Printability filters remove those configurations that are incompatible with the printer or material used, as well as those solutions that have undesirable post-processing requirements. The candidate designs that meet printability standards are then presented to the user.

In some embodiments, a user may be allowed to define areas of interest, which would be used to re-evaluate voxel size, shape, or beam cross section to control deflections, stress, or strain affecting the areas of interest. The user may use areas of interest to closely assess the performance of candidate structures within these areas to ensure requirements are met. The user may then refine voxel characteristics to achieve a desired effect. Once the requirements for an area are altered, the AI model then re-evaluates the candidate structures to produce a refined set of solutions that reflect the changes to user specified areas of interest.

The application may also adjust the lattice alignment of the entire structure, or in some cases each zone, based on the resultant external force affecting the structure, or zone. The forces affecting the structure are summed into a resultant force, and the lattice may be aligned to be orthogonal to the resultant force, which represents the best lattice alignment to support the forces. Once the primary force-based evaluation is done, secondary evaluations, e.g., for internal forces, thermal effects, vibration, cyclic loading (fatigue), or other physics, may be conducted, and lattice orientation and/or zone designation, i.e., zone number, size, and shape, may be adjusted to best respond to these secondary considerations.

In some embodiments, system may be configured to design structures using empty space geometry. Where the standard approach is to choose the lattice, the cell size, and then adjust the beam thickness, when the geometry of empty space is configured, the empty space within a lattice is adjusted instead of the beam size.

The empty space configuration procedure uses a standard voxel shape repeated throughout the build space with the same periodicity. The standard voxel shape defines the space that is occupied by the voxel, with negative or empty space defined within each cell as the volume not occupied by beams or nodes. This negative space may be filled with new structural elements having a shape and maximum volume set by the empty space, and the periodicity of the new structural element must be repeated within each cell of the lattice. Negative space may be filled with shapes of the same or different material as the main lattice, and the shapes may be fixed or moveable within the negative space and relative to the main lattice. Moveable shapes within a cell may be used to tune thermal transmissibility, dampen vibrations, or other purpose, without dramatically affecting the strength and stiffness of the main lattice.

In some embodiments, negative space may be filled with a variant of the main lattice shape, allowing the use of a second lattice located in the negative space to improve structural performance, either a primary performance requirement or a secondary performance requirement. Alternatively, negative space may be filled with a fluid or other material. Such use of a secondary fill material would allow the main lattice to respond to inputs. For example, assume a piece of armor plating is designed with a primary lattice and viscous fluid secondary fill material. When the armor plating absorbs a ballistic impact from a projectile, the solid portion of the structure, i.e., the main lattice, moves and thereby deflects the projectile out of its intended path. Meanwhile, the secondary fill material, e.g., a fluid, dissipates the impact energy of the projectile across the structure due to the incompressible nature of fluid and its ability to transmit pressure waves.

In some cases, a secondary lattice located in the empty space of a primary lattice is configured to move independently of the first lattice. An independently moveable secondary lattice may change the weight ratio or natural frequency of a structure, and would allow for structural alignment to gravity, or to external force loading.

### CONSTRAINTS DUE TO MANUFACTURING EQUIPMENT

In some embodiments of the disclosed invention, design constraints are imposed by known interactions between designs and their translations by additive manufacturing equipment, rather than physics or geometric constraints. Because their importance to the viability of any design, characteristics of the 3-D printer, the material, and post-processing techniques are required inputs for an AI model training database when the application designs a structure.

### MANUFACTURING CONSTRAINTS: ALIGNMENT TECHNIQUES

Candidate designs must account for manufacturing constraints to ensure the printed structures have expected internal and external alignment characteristics. The 3-D printer used to print the design must be accounted for to ensure proper alignment. For example, for some 3-D printers, temperature differentials within the printer and printer bed cooling cause material to shrink more in the x and y directions, and less in the z direction, i.e., up from the plane of the printer bed. Such asymmetric part shrinkage can dramatically affect beam and cell alignment. Similarly, the type of material used to print the structure has properties that may affect alignment. For example, some materials shrink after cooling, e.g., polylactic acid (PLA) shrinks about 0.3%, while nylon shrinks about 0.7 to 0.8%. Shrinkage amounts also vary with ambient temperature and humidity. While shrinkage in the z-axis is managed by the placement of each filament layer, shrinkage of the x- and y-axes occurs as the printer bed cools, typically resulting in a 0.5% to 3.0% overall shrinkage of the dimensions of the structure’s base. Base dimensional shrinkage must be anticipated, and designs must be adjusted based on the printer used, the printer’s operating temperatures, printer speed, material used, and ambient temperature and humidity.

### MANUFACTURING CONSTRAINTS: TRANSLATION OF DESIGNS

Translation of designs is another critical function of the disclosed invention. Structures designed for one type of printer, or even a particular printer, may need to be translated to another printer or printer type. For example, printers may use lasers of different intensity, power, or diameter, requiring adjustments to the design.

In some embodiments, the system is configured to translate structural designs to a different machine from the machine on which the structure was originally designed to be manufactured. The translated design may be used with the same material as originally designed, or with a different material. In other cases, a design may require translation to a different version of the outer shell and lattice for use with a different process, material, or construction method.

In practice, the application may use two sets of real-world test data to convert a structure and lattice designed to be printed on a first machine to a structure and lattice suitable for printing on a second machine or with a different material. For example, the two data sets include a first data set for a first structure for printing on a first 3-D printer using a first material, and a second data set for a second structure for printing on a second 3-D printer using the first material. The creation of the two data sets involves use of a first set of test parameters to create the first model and a second set of test parameters applied to the first model to create the second model. Manufacturing includes switching from the first set of parameters used in conjunction with the first model to the second set of parameters to create the second structure. The change of printer or material may be user defined. The first model outer shell and the second model outer shell may be the same, or alternatively, the second model shell may be derived from the first model shell.

### TRANSLATION OF DESIGNS: DIFFERENT MACHINES, SAME TYPE

In some embodiments, designs may require translation for use on different machines of the same type. For example, a particular model of printer may come in multiple versions, or there may be multiple copies of a particular model of printer, or a specific type of printer, e.g., a selective laser melting (SLM) printer or an electron beam melting printer, may be produced by different manufacturers.

Similarly, a design may require translation when a different material is used, even when printed on the same instance of a machine. For example, an aluminum powder bed material will behave differently than a titanium powder bed material, as will powders of different sizes. Multiple levels of translation may also be required, for example, a design optimized for one printer and material must be translated for use on a different type of printer using a different material. Changes to the voxel lattice for translation from one metal (or plastic) to another will likely be less significant than changes required to translate from a metal to a plastic. For the latter category of translation, more substantial changes to the voxel lattice than a mere adjustment to beam thickness will likely be required. For example, smaller cells may be used in place of larger ones, creating a more complex overall lattice. Similarly, arranging more cells in parallel would make the structure stiffer, while arranging more cells in series would make the structure relatively more flexible.

One key difference that may arise from one machine to another machine of the same type is the size of the laser used. For example, SLM printers range in power from 200 watts (W) to 1,000 W, and may have spot diameters ranging from 30 micrometers (μm) to 100 μm.

Minimum beam cross-section threshold will typically be constant for a given machine and material. In general, two machines of the same type will typically use the same configuration file, however, a more highly tuned configuration file may be used for each specific printer. The application configured with a base or standard AI model for a given device and material may be specially tuned to have a higher predictive accuracy when the device and material are used in a specific location or under specific environmental conditions, or the AI model may also be tuned to specific print settings on the device. However, such tuning adjustments are device-specific and would not apply to uses of the standard AI model.

The minimum negative space within the voxel may be adapted to ensure a design is compatible with another printer, and/or with post-processing requirements. For example, post-print cleaning of structures printed using fused deposition modeling (FDM) is difficult, as there are limited options to remove support structures. In general, the structure is designed so that 1) no supports are required; 2) supports can be mechanically removed by hand, or 3) supports can be chemically removed using a chemical bath. Of these options, creating a design that does not require supports is optimal, but is not possible with all designs. Mechanical cleaning is fast but only can be done for structures having accessible supports. Chemical cleaning is thorough but is slow and may require the use of hazardous materials, making it a less desirable option.

In light of these considerations, the acceptable voxel shape for a design may be selected to facilitate the access required for waste material removal given the removal technique to be used. For example, if the structure required mechanical removal, the size of the removal tool may be used to define the minimum negative space in the lattice. Such lattice sizing would ensure that the tool could access and remove the waste material from the lattice. As another example, in the case of chemical cleaning, the pressure and viscosity of the solvent or cleaning fluid and the type of material being removed from the lattice will drive negative space requirements. Negative space may be defined as a ratio of the fill volume of the structure, so that negative space may be scaled up or down depending on the structure, manufacturing process, cleaning process, etc. Similarly, the application may assign a complexity grade to a candidate design based on the post processing requirements.

### TRANSLATION OF DESIGNS: DIFFERENT MACHINES, DIFFERENT MATERIALS

In some embodiments, designs may require translation for use on different printers using different materials. For example, the build direction of the lattice may be oriented to produce through passages within the structure to allow fluid movement, which in turn allows solvent to flow freely to remove waste material. Alternatively, the lattice structure or the outer shell may include open spaces or holes to facilitate the removal of materials from within the lattice. For printer types that use fluids in the printing process, e.g., stereo lithography (SLA), a flow path out of the structure is required to allow the resin and cleaning solvents to drain. However, if there are cavities in the part that cannot be completely drained, solvent will remain inside the structure and may dissolve uncured resin before the part is considered complete. To prevent solvent capture, designs may include voids or access openings in the outer shell, or between voxelated areas to allow manufacturing fluids or cleaning fluids to drain from the structure. As another example, some printers use a sand blasting process to remove waste materials. The grain size of sand blasting materials, as well as access points to internal areas by sand blasting tools may affect structural design. Similarly, the powder size for materials used in, e.g., selective laser melting (SLM), or directed energy deposition (DED) machines, may affect post-processing requirements and therefore structural design to create passages to allow removal of waste materials. In some embodiments, the application assigns a complexity grade to a design to indicate how difficult post-processing will be for the printed structure.

In some embodiments, the build orientation of a design may be considered during voxelization of the structure. A user may define a print direction based on factors that include printability of both the lattice and the outer shell. For example, the shell may have features that make certain orientations more or less advantageous for printing. Similarly, the lattice may have features that may be more or less difficult to render depending on the lattice orientation. As a result, the optimal orientation for the shell and that for the lattice may differ, requiring either 1) choosing an orientation that favors either the shell or the lattice, or 2) rejecting solutions that do not converge on a build orientation that is acceptable for both the shell and lattice.

To resolve build orientation conflicts, the application may evaluate the contact angles of the beams with the outer skin. For example, in cases where the shell comprises a flat solid layer on the top of the lattice structure, the application may alter the design to prevent lattice fracturing caused by peel forces that arise when the part is removed from an oxygenated fluorinated ethylene propylene (FEP) film, such as is used with SLA or digital light processing (DLP) printers. Similarly, in fused deposition modeling (FDM) printers, gravity and heat cause may material to sag before it adequately cools and hardens. In these cases, lattice orientation may be adjusted to minimize such sagging.

In some embodiments, a structure designed for construction out of a polymer, e.g., acrylonitrile butadiene styrene (ABS) may be transitioned for use with a metal, e.g., titanium. Such a change may be necessary, if, for example, the only viable solutions using the polymer included overly thick beam cross sections that prevented effective support material removal or resulted in very little or no negative space in the structure. One change required to perform this transition is determining a minimum beam thickness, since the polymer solution resulted in undesirable beam thicknesses.

In some embodiments, the solution parameters for an existing design may be used to set the default parameters for a second design to translate the existing design from one machine or manufacturing method to another. Starting from the existing design allows the application to develop the new design using only a subset of the data used to create the existing design. The data subset is selected using an algorithmic sampling of the original data and the shapes already created for the exiting build. Sampling methods may vary depending on the application, ranging from a relatively inefficient random sampling of existing designs to more sophisticated methods. Typically, the application will sample a random 10% subset of the designs that were created for the primary dataset. The entire sampled subset will be shapes that have been previously printed in the primary dataset. If the application identifies a very good correlation between models, new data may be created that explores and informs both models.

A specific design solution cannot be moved from one material or machine to another without some translation. This is because a design solution for a machine type, construction material, environmental condition, and lattice shape will be rendered by one AI model, while changing any one of these parameters will typically require a different AI model trained on an appropriate database to render the design. For example, if the user wants to use acrylonitrile butadiene styrene (ABS) on an FDM printer with a BCC lattice shape, the application will use a first AI model, and if the user wants to use ABS on an FDM printer with an FCC lattice shape, the application will use a second AI model. As another example, if the user wanted to design a structure from titanium on the Xact XM200G printer with a BCC lattice shape, the AI model used for the task would be trained on data relevant to that material used on that printer model with that lattice shape. The application will run the AI model and generate candidate designs independently of solutions generated for other combinations.

In some embodiments, translating a design from one printer to another may be aided by examining 2-D projections of the surfaces of the structure to visualize the spaces available for tools, viscous fluid, or solvents to flow through the shape. Use of a 2-D projection is a more computationally efficient means to evaluate structures than use of a full 3-D rendering.

Translation of designs from one material to another typically requires the training and use of a different AI model. Translation from one material to another may therefore me streamlined by creating a foundational AI model for each type of material, such as ceramics, plastics, metals, etc. Once the application develops a foundational model for a given material, the model may be trained on additional relevant data, e.g., for a printer type or lattice shape, to develop a new AI model. A foundational model may require as many as 10,000 structures per training, but once it has been created, creating a foundational model for a similar material requires relatively fewer training structures. For example, with a foundational model in hand for one metal, a foundational model for a similar metal may be developed using the first metal’s foundational model and 1000 parts manufactured from the second metal. Once the system trains the foundational model for the second metal, parts may be built out of the second metal independently of the foundational model for the first metal.

Each AI model generates structural configurations that are unique to a specific machine. A configuration file is a dataset populated based on the specific machine’s characteristics in combination with the construction material and is created with empirical data. To develop the required empirical data, the printer may be tasked to print a plurality of test structures using the material. The test structures are then measured and evaluated in various ways to develop the data. For example, the structure may be visually examined for structural integrity, subjected to crushing pressure to measure strength, vibrated to assess dampening performance, the crossbeam thickness and voxel size may be measured to assess consistency or adherence to the design, or other suitable tests. By use of empirical testing to construct configuration datasets, the performance of a printer may be characterized without knowledge of the printer’s internal process.

The test structures represent a plurality of sample geometries that test one or more capabilities of the printer. For example, a beam thickness geometry is configured to identify the minimum beam thickness printable by the printer when using the material. The beam thickness geometry may include, e.g., a series of walls having progressively decreasing thicknesses. By printing this sample geometry, the minimum feature thickness of the printer can be determined, without knowledge of the type of printer. A configuration dataset may be provided to users, who may add their own limitations to the model to refine printer capabilities for their manufacturing operation. For example, if a user knows that machine A can print 2 mm minimum features and machine B can only print 5 mm minimum features, the user may instruct the model not to suggest solutions below 5 mm for machine B, even if the model includes valid solutions below 5 mm that could be printed on machine A.

### TRANSLATION OF DESIGNS: DIFFERENT MATERIAL TYPES

In some embodiments, the system translates structures from one material to a different type of material, e.g., a metal to a plastic. Structural differences between designs constructed of such different materials will flow from the properties of each material. However, the network effects of the lattice will prevent a simple translation of a design to a different material type based solely on the inherent differences between the two materials. For example, assume a first design using material A, and a second design using material B, where material A has double the stiffness of material B. Despite the difference in inherent stiffness of the materials, the second structure will not be twice as stiff as the first structure. The change of material changes how Svoxels interact with each other, how the beams bend and break under loading, and how strain causes displacement within the design. In short, change of material introduces cascading differences in performance that the system must accommodate to successfully translate a structure from one material to another.

When structures undergo such transitions, it is likely that Svoxels will require adjustments that are more involved than a mere change in beam thickness. For example, voxel size may be reduced to create a stiffer, but more complex structure having more nodes and more beam-to-beam interconnections. Other parameters that may require adjustment are voxel shape, packing configuration, voxel orientation, and zone designation. With respect to packing configuration, a lattice structure may be adjusted to place more Svoxels in parallel to increase stiffness when transitioning to a material with more inherent flexibility. Conversely, the lattice may be altered to include more Svoxels in series to reduce stiffness when transitioning to a material with greater inherent stiffness.

Lattice orientation and zone designation also may require adjustment to translate a design from one material to a different type of material. For example, a structure may be divided into more smaller zones, or the lattice within the zones may be reoriented, or smaller cell sizes may be used to increase voxel density, or multiple cell sizes may be used to compensate for the different performance characteristics of the new material.

While typically the AI model and FEA analysis are used to define the composite forces on the structure, as well as build spaces, zones, and orientations, in some embodiments, the application may provide the user an option to define “special” volumes that would be packed and analyzed separately. Special regions may be appropriate for design tasks wherein there are characteristics that are not accounted for by the AI model, e.g., a requirement to maintain clearance with another structure, a center of gravity location requirement, a requirement to maintain a line of sight through the structure, etc. Such a user-defined override of the default characterization of the build space would allow the user to define areas of special interest that require separate analysis and solutions from the default method.

### TRANSLATION OF DESIGNS: CONVERSION TO TRADITIONAL MANUFACTURING

In some embodiments, structural designs may also be translated from an additive manufacturing process to a more traditional manufacturing method, e.g., CNC machining, EDM etching, die casting, etc.

In some embodiments, the system is configured to allow conventional manufacturing techniques by allowing adjustments of the lattice orientation, zone division of the lattice fill area, and voxel packing configuration. For example, the application may alter a structural design to allow cutter access into an interior area of the structure, to achieve an injection molding directionality that eases release of the structure from the mold, and other accommodations. One technique for achieving this accommodation is to use 2-D projections of the lattice to bundle lattices. Such 2-D projections allow the application to group together shapes that are dissimilar in 3-D, but that are similar in their corresponding 2-D projection. By grouping shapes according to 2-D symmetry without considering thickness or depth, the largest and smallest gap sizes on a structure becomes apparent. With the gap size range in hand, the user may establish optimal tooling distances, and also determine which structures have the highest probability of a successful conventional fabrication. Another available technique is the use of specific lattice shapes, such as a honeycomb shape, that have been developed for specific manufacturing methods and that are effectively 2.5-dimensional (2.5-D) structures. A 2.5-D structure is a structure that wherein the user may define a thickness in one direction, and then fill a Svoxel with the shape, forming a solid wall in a single direction. Then, the user may continuously vary the height of the shape to perfectly match the structure. Such a 2.5-D structure may be extruded in one direction, allowing the structure to be aligned with a build direction, so that access for post manufacturing processing is always available. In the simplest version of adjustment to conventional manufacturing, the user may define the manufacturing orientation and the load orientations.

In some embodiments, a voxel-based structural design may be modified to allow post-build processing by conventional manufacturing methods. For example, the printed structure may include additional thicknesses in the shell boundary conditions designed to allow post-build machining to improve the structure’s dimensionality, or to allow conventional treatments to create a specified surface finish on the final product. Another requirement is to include fiducials in the external shell to allow the printed part to be fixed in a conventional machining center and to align the machining center’s measurements to the printed geometry. Similarly, internal lattice arrangements may be modified to leave solid regions after post-build machining, or to add solid areas to allow for additional post-build removal of material. Post-build machining may, for example, provide for better mating between the printed structure and other structures, or may allow the creation of a machined finish that is strong enough to interface with the voxelated interior without impinging on the lattice structure. Conventional post-build machining may, e.g., reduce the amount of material required for the machined finish, or may enhance the structure’s performance relative to various physics constraints, such as stress and strain. Such techniques allow the construction of structures without wasting as much material as conventional manufacturing methods alone.

### MANUFACTURING CONSTRAINTS: CONSTRAINTS DUE TO DEFECTS

The disclosed invention also includes systems and methods for managing the presence and impact of defects resulting from translation of the generated design to manufactured structure.

### CONSTRAINTS DUE TO DEFECTS: PRE-DEFINED FAILURE MODES

In some embodiments, AI models have access to pre-defined behavioral characteristics of manufactured structures that indicate potential for structural failure due to accelerated fatigue or structural weaknesses. For example, the AI model may adjust voxel density or size to compensate for areas experiencing higher stress versus areas experiencing lower stress.

The disclosed system may use one of a number of means to determine whether portions of the design are more susceptible to overload and therefore require a lattice adjustment to compensate. One means, known as geometric analysis, is to examine the structure for areas with high propensity for fatigue. Fatigue tends to originate from a mechanical defect and propagate from there throughout the structure. Once areas prone to fatigue are identified, the structure may be adjusted in those areas to eliminate or mitigate the effects of the defects. For example, beam thickness may be increased in such areas, since a 0.8 mm defect on a 3.0 mm beam is relatively more consequential than a 0.8 mm defect on a 100 mm beam. Similarly, when using an elastomer or other flexible construction material, altering the shape or beam thickness may reduce fatigue risk. Likewise, altering the material used in a fatigue risk area can reduce such risk. The system also may compensate for different stress levels by adjusting voxel density or size, for example, areas of higher stress may best be constructed using smaller or more densely packed Svoxels.

Another method is to examine the structure and material together by performing an FEA screen, iso-geometric analysis (IGA), ML-accelerated FEA analysis, or other suitable method known in the art of engineering analysis, to map how forces on the external shell transfer into the internal lattice. The FEA analysis is used to generate a stress map (or map of other physics constraint) showing the translation of the external force to the lattice. Using the mapped values, the internal lattice is divided into regions based on the amount of stress the region experiences. Then the lattice structure is tuned to accommodate the stress experienced in that region. For example, regions experiencing lower stress will have relatively thinner lattice elements, improving overall efficiency of the part. Interfaces between regions may be continuous ramps to avoid concentrations of stress at the interfaces.

### CONSTRAINTS DUE TO DEFECTS: BOUNDARY CONDITIONS MITIGATION

Some embodiments of the disclosed invention include systems and methods to reduce the effects of local boundary conditions relative to manufacturing the lattice or the attachment locations of the exterior shell to internal structures.

For example, the internal lattice structure may be adjusted relative to outer shell geometries. The internal lattice type and size may be adjusted locally in response to a section of the external shell to compensate for higher stress concentrations caused by the external shell interaction with the lattice. Such stress concentrations may be caused by internal lattice configurations that result in sharp corners, poor continuity between lattice layers or between the lattice and the shell. In some cases, support structure or cleaning flow paths and access points may also locally increase stress concentrations. High stress areas may also result from outer shell geometric features or from attachment issues arising from mating adjacent sections of the shell or mating the shell with the internal lattice. Adjustments to the lattice in response to such access points, geometric features, attachment issues, etc., would produce local changes to the lattice in the vicinity of such features.

For example, designs may be configured to decrease sensitivity to manufacturing process variability. Sensitivity to manufacturing variability can cause a design to be printed with excess material, insufficient material, contamination, or interlayer bonding. Sensitivity is increased for materials having an unfavorable thermal history, or due to unfavorable machine calibration for displacements or energy applied.

One means of decreasing sensitivity is to adjust the lattice shape or size. Different lattice shapes will have different sensitivities to defects and manufacturing peculiarities. Overbuilding the design may compensate for variance. For example, if a typical manufacturing variability for a lattice shape is +/- 5%, the design may be adjusted to overbuild the lattice by 10%, resulting in either +5% or +15% variance, ensuring the structure always exceeds requirements. In this way designs may be configured to have associated confidence levels, e.g., the design printed on Machine A will fall within 5% of designed specifications, while the same design printed on Machine B will be within 15% of specifications.

Some lattice shapes are inherently less sensitive to manufacturing variance. For example, TPMS structures are substantially less sensitive to variance than beam and node structures. In general, the more beams present in a design, the more sensitive the design will be to manufacturing variability. Similarly, designs with fewer larger cells are less sensitive to manufacturing defects than designs with more smaller cells. Designs having sharp corners, voids, warpage, or geometry changes will be relatively more sensitive to manufacturing variability. Using these general sensitivity characteristics, candidate designs may be ranked based on their sensitivity to defects.

Cell size and lattice arrangement may be used to control the level of adhesion to the printer base plate. Excess or insufficient adhesion to the base plate can cause a design to warp or become distorted as the material cools during printing or during final cooling after printing.

Residual stress within the lattice can also cause distortion or warpage at the edges of the structure. To mitigate such distortion, cell size may be reduced to limit the amount of material that must cool and to increase the surface area to improve cooling. Adjusting cell size also increases or decreases the number of interface points between the external shape and the internal lattice structure. Likewise, larger cells and/or thicker lattice may be used to improve rigidity locally in areas prone to distortion or warpage. Another potential source of distortion to designs is external damage to the lattice. Areas prone to such damage may be reinforced. Another source of distortion is internal residual temperatures remaining after printing, such within areas having more material mass. Crystallinity may result in increased shrinkage and warpage for certain construction materials.

Structures are also subject to distortion or warpage from the effects of assembly of multiple individual parts of a structure. Attachment points and interconnections between parts are particularly likely to experience high levels of stress. To accommodate such stress concentrations, cell size for voxelated structures and periodicity for TPMS structures may be adjusted to increase the rigidity, flexibility, or strength around assembly mounting locations as described elsewhere herein.

### CONSTRAINTS DUE TO DEFECTS: EXTERNAL DAMAGE

In some embodiments, the system is configured to adjust lattice structure in order to minimize the effects of external damage on structural performance. Some embodiments account for internal residual temperatures and the strength of the lattice.

The system may adjust packing configuration, voxel shape, or zone designation to minimize the effects of external damage to the shell or lattice on structural performance. External damage may originate from printing, unpacking, assembly, or operation of the structure. A first line of defense is protecting the lattice by use of the outer shell as a protective layer. Another method to use a printability filter to identify thresholds that provide damage protection for different machines and materials. The printability filter is developed for a lattice shape using a series of tests that are run on the lattice shape with specific materials and printers to determine printer capabilities for those materials. Printability filters automatically remove a large number of non-manufacturable designs from the solution space before the designs are presented to a user. For example, the printability filter may determine that a fluorite lattice requires a 1:10 solid to empty space ratio and a minimum beam thickness of 2.0 mm to reliably print on a given printer. If an AI model generates a design that fails to meet these two thresholds, then the candidate design will not be presented to a user.

In some cases, a structure may be designed to absorb impacts or energy. For example, lattice orientation may be adjusted to provide additional strength to counter the impacts, and internal voxel, voxel-to-voxel, lattice-to-lattice, or lattice-to-shell interconnections may be reinforced in the affected area. Such changes are intended to isolate and absorb impacts, while allowing lattice structures in the affected area to operate as intended even if individual cells are damaged. For example, a lattice may be constructed with one or more stronger layers near the impact area, with layers further away from the impact area reverting to the strength required for normal structural performance. Similarly, a lattice may include specialized interfaces between layers, wherein the interface is a solid structure, or may include a void space. Including a void interface between layers would tend to isolate impacts by providing poor force transmission across the void. As another example, a structure may better absorb impacts or energy by use of continuously variable beam thicknesses. With further reference to FIG. 6, a variable lattice 600 is depicted that tends to minimize force transmission in the direction opposite the arrow 12.

### CONSTRAINTS DUE TO DEFECTS: ASSEMBLY

In some embodiments, the system accounts for assembly factors by adjusting attachment points and interconnections that experience excessive stress or strain. By reinforcing or altering such areas, their influence on overall structural performance is mitigated. Cell size and periodicity also may be altered to adjust strength, rigidity, or flexibility near attachment points between the lattice and external shell. Such adjustments would minimize the stress concentrations around the attachment points or alternatively increase their load strength to reduce the probability of structural failure in these areas.

### CONSTRAINTS DUE TO DEFECTS: USER INTERFACE IRREGULARITIES

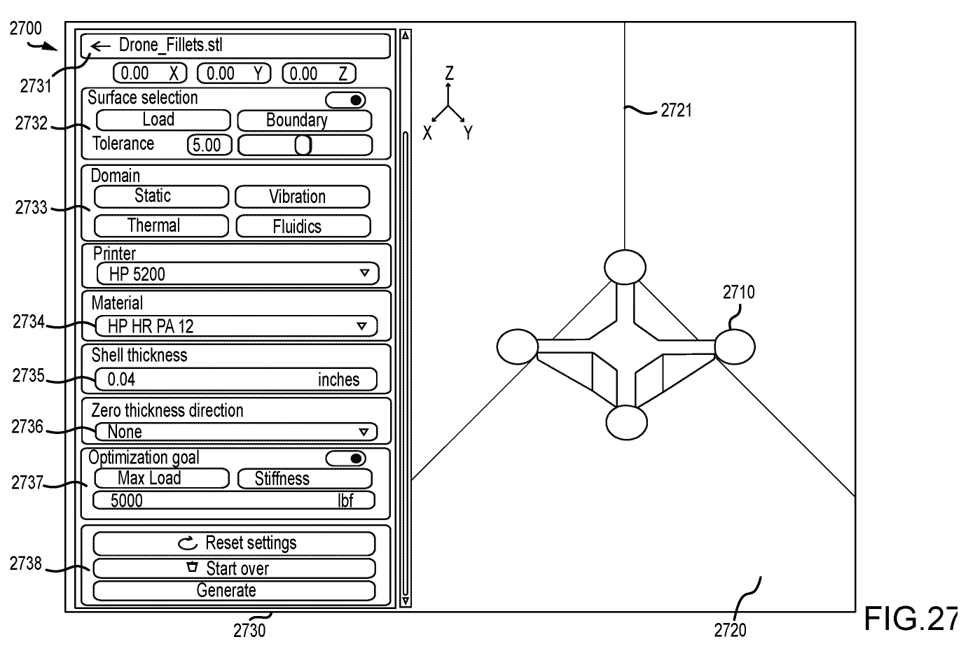

In some embodiments, the system uses a graphical user interface to allow a user to provide design inputs for a structure. Through the GUI, a user may provide configuration inputs, such as supplying a ranking scheme for the candidate designs, expanding or constraining the set of presented designs, or sorting the presented designs according to one or more variables, e.g., material cost, beam thickness, lattice type, voxel size, etc. With reference to FIG. 27 is depicted an example GUI 2700 showing an overview of a structure 2710 as imported into the application. The GUI includes a design window 2720, and a control panel 2730. The design window includes a three-dimensional axis 2721 and may be used to manipulate the structure for design purposes. The control panel includes a plurality of frames through which a user may supply various inputs to the application to specify the characteristics of the designed structure. For example, the control panel may include a file frame 2731 that identifies the file containing the structure. A surface selection frame 2732 contains, e.g., radio buttons, sliders, number fields, text fields, etc. to adjust structural load requirements, establish boundary lines, and to set an error tolerance. A domain frame 2733 allows the user to select a physics domain, e.g., static loading, vibration, thermal conductivity, or fluidic movement. A material frame 2734 allows the user to select a construction material using, e.g., a dropdown menu. A shell thickness frame 2735 allows the user to specify a thickness for the external shell. A zero-thickness selection frame 2736 allows the user to select a direction of the outer shell that would have a zero thickness, such as where a plane and the shell are coincident. An optimization goal frame 2737 allows the user to set a primary optimization goal, such as static loading or stiffness. A command frame 2738 allows the user to reset or discard changes to the structure file, or to generate candidate designs for the structure.

In some embodiments, the application includes a token payment scheme that allows a user to purchase credits or tokens for use within the application. The token payment scheme is facilitated by use of a GUI pop-up screen that informs the user of the user’s balance of tokens available to spend, the token cost for a selected action, the number of tokens the user will have remaining after the action, the user’s token subscription plan, or other suitable information facilitating token payments for accomplishing design tasks within the application. Also included in the pop-up screen are confirm and cancel radio buttons to allow the user to proceed with or to cancel the selected action. In some embodiments, users are charged a periodic access fee within a subscription-based model for access to structure design services. Some embodiments use a combination of consumption and subscription.

### STEREOLITHOGRAPHY COMPUTER AIDED DESIGN FILES

In some embodiments, the application produces outputs in a stereolithography CAD file (.STL). Such embodiments represent a different approach than the lattice fill structural design methods described elsewhere herein. According to such alternate approaches, the application converts .STL file outputs into tool paths with a slicer program to generate a printable structure for a printer to construct. Most printers include an onboard slicer program that is configured for the printer and its manufacturing method. Third-party slicers may also be used that have been developed independently form the printer manufacturer, and that provide additional capabilities. Such slicer programs may be used by the application to feed commands directly to the machine for printing. Specialized slicers that are not required to receive a structure solution and then devise slices that are representations of the shape for tool path constructions are able to produce more elegant designs and shapes. The application delivers an .STL file to the slicer, which then exports a geometric code (.gcode) file that is readable by the machine.

### STEREOLITHOGRAPHY: LATTICE APPROXIMATION

In some embodiments, the system uses machine learning lattice approximation rather than the lattice build space structural design methods described above. An .STL structure file includes a generated lattice mesh that defines the shape. The .STL file is then input to a slicer program to create the tooling paths for a printer. For example, assume a candidate structure has a generally cylindrical structure that will be filled with a lattice mesh. The first AI model could use an approximation of the cylinder shape that has been created by a second AI algorithm. Such a stepped approach to lattice generation allows the application to operate much faster than if the model were required to both generate cylindrical shape approximation and fill the shape. Use of the approximated shape results in a more natural, i.e., fluctuating, or varying perimeter circumferential shapes, that are mechanically indistinguishable from the .STL file which uses triangles to make the smooth shape. Use of the approximated cylinder results in roughly the same number of triangles and is calculated faster. In some cases, the technique may result in more manageable triangles while requiring a similar compute time, resulting in smoother part surfaces at printing.

### STEREOLITHOGRAPHY: STL CONVERSION

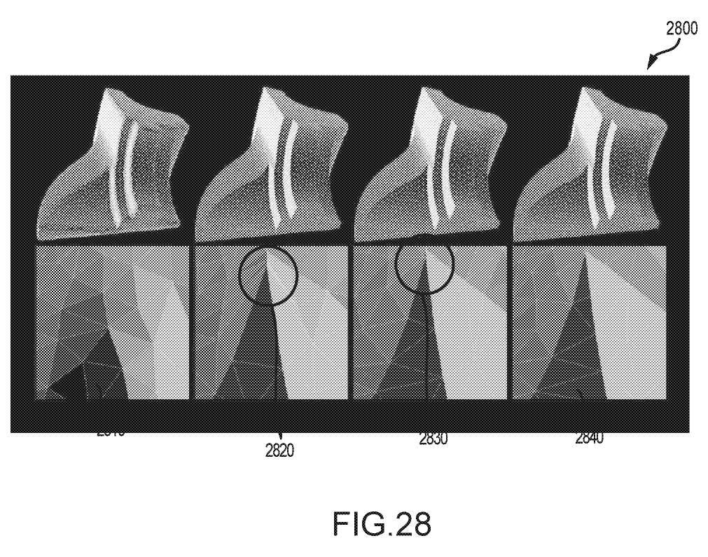

In some embodiments, the .STL file may be converted to a more uniform mesh shape that can be analyzed using conformal analysis of the external skin stresses and the geometry of mating to the voxel lattice. With reference to FIG. 28 is depicted an exemplary process 2800 for performing mesh surface conversion. For example, the output mesh shapes may be scrambled so that they resemble equilateral triangles 2810, which allows the application to perform more accurate and faster numerical simulation and post processing procedures, while representing the same overall shape as the unscrambled mesh. In some cases, the .STL file of the design space is mated to the external shell so that the shell is essentially unrelated to external loading. By converting the .STL file structure to a uniform mesh, the application is able to subject the shape to FEA analysis to determine the internal forces the shell will exert on the interfaces with the lattice shape. FEA analysis of the .STL file printing geometries may be performed after shape generation. Such analysis will result in the creation of internal skin variations and mating structure to tune the interface between the lattice and the shell. Variations in the external shell thickness or lattice structure may be used to improve the interface. This tuning will result in leaner, stronger combined shapes where the stress concentrations caused by the shell are accounted for in the interface with the underlying lattice. The processing time needed to perform FEA analysis on an output from an internal lattice generating negative space would require excessive computing resources. However, if the lattice network is converted to a standardized surface or volume mesh for analysis, it can be analyzed in a reasonable amount of time and then re-translated to the lattice.

The disclosed process is also configured to eliminate surface structure artifacts 2820, 2830 that may arise when generating a surface mesh. These include adding overlaps, removing voids, performing error checks, and normalizing the surface mesh 2840 to create an accurate volume mesh upon conversion. If such artifacts are not removed, when a surface mesh is converted to a volume mesh, such artifacts will cause irregularities and errors in the volume mesh. For example, if an irregular surface mesh with larger elements over the general surface and smaller elements in the more detailed areas were converted into a volume mesh, the smaller elements would create minute areas in which FEA analysis would fail and the resulting surface would not accurately approximate the shape. Removal of surface artifacts therefore allows the application to scale voxels without multiplying errors due to irregular math and also reduces commuting time since so many solutions would otherwise be necessary.

### EXEMPLARY PROCESS FLOW

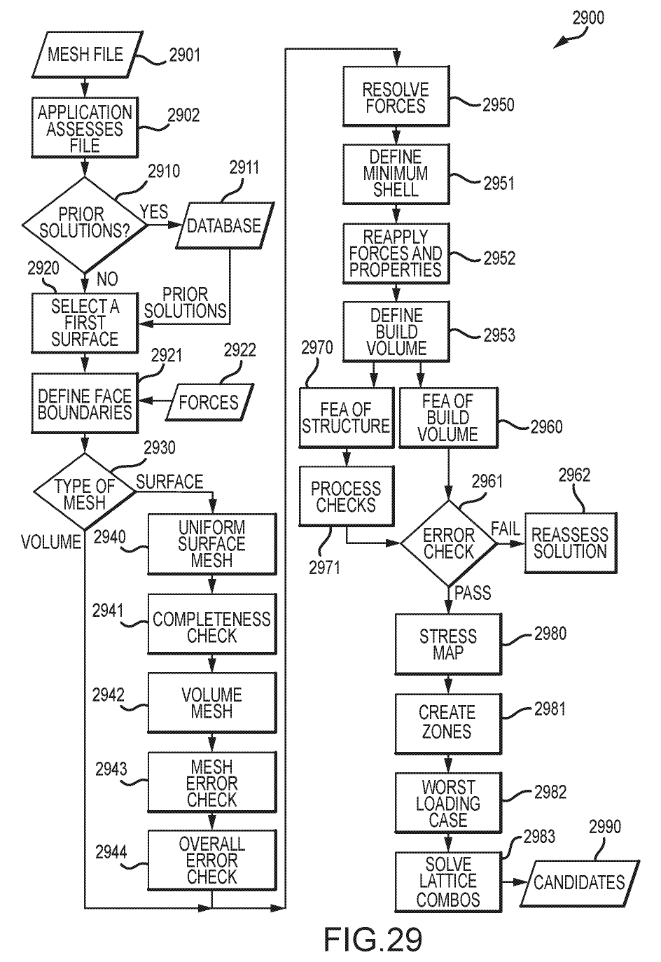

With reference to FIG. 29, a flow chart 2900 depicting an exemplary process flow is shown, as used in embodiments of the disclosed invention. To initiate the design of a three-dimensional structure, at block 2901 a user uploads a mesh file of the structure into the application, which at block 2902 assesses the file type. The mesh file may be a surface mesh file, e.g., .STL, .OBJ, or 3MF file, that includes a 3-D representation of the surface of the structure, or may be a volume mesh file, e.g., Parasolid, STEP, IGES, or ACIS file, that includes a 3-D representation of the volume of the structure. Typically, the file type will be a 2-D .STL file that was outputted from 3-D modeling software. However, since such files are 2-D surface meshes intended for 3-D printers, they are only configured to create a 3-D surface without regard to the interior structure. At block 2910 the application accesses a library of previous solutions stored in a database 2911 to determine whether the library includes solutions previously generated for the structure. If such a prior solution exists, the application will include the previously generated solutions in the process as examples of viable solutions for the structure.

At block 2920 The application then selects a first surface of the structure to process wherein the first surface is a portion of the exterior surface of the structure. In the case of an .STL file, the application employs a crude edge detection algorithm to select all of the triangles of the selected surface and at block 2921 defines the surface boundaries. The application continues to select a second surface, and so on, until the structure’s exterior surface is fully characterized, i.e., all of the surfaces are defined, and the boundaries of the surfaces are set in the format of the uploaded file. With the surfaces characterized, at block 2922, the application applies the external forces, or other physics constraint to the structure. At block 2930 the process diverges depending on whether the uploaded file is a surface mesh or a volume mesh. In most cases, if the uploaded file is an .STL or other surface mesh file, conversion to a volume mesh is required to create a volume that can be voxelated. If the uploaded file is a surface mesh, at block 2940 the application converts the surface mesh with concentrations into a more homogeneous mesh, eliminating the smaller mesh concentrations that would cause artifacts in the soon to be created volume mesh. Such conversion is required if the uploaded file is an .STL file. Next, at block 2941 the application evaluates the uniform surface mesh for errors, e.g., overlaps, gaps, or open faces, to ensure the surface is complete. For example, the application may check ESPR error against a threshold, e.g., 0.00001 to 0.00010, with an ideal of 0.00500. At block 2942 the uniform surface mesh is then normalized and converted to a volume mesh. At block 2943 the application checks the volume mesh for conversion errors to ensure the conversion process was properly accomplished. The application checks to ensure, for example, the size of the volume mesh relative to the overall volume, with an exemplary target of 1/1400 of the largest dimension, and checks nodes, indices, and consistency. Volume mesh error targets are device and material specific. At block 2944 the application then checks that all of the detected errors in the volume mesh are below a threshold to ensure the shape is viable.

With the surface mesh files properly converted to a volume mesh, at block 2950 the process continues for both file types. In the case of a surface mesh file, all of the forces and the surface boundaries upon which each force acts are reduced to a single resultant force and constraint set. At block 2951 the application next creates a second volume that is slightly smaller than the overall structure volume. The second volume represents the largest space that can be filled with lattice structure. The difference between the second volume and the overall volume is the minimum shell thickness of the generated structure. The default minimum shell thickness may be adjusted by a user.

At block 2952 the application applies properties to the volume mesh file, e.g., the overall shell volume, the chunk volume, and facets, and re-applies the individual force vectors with the surface boundaries. Using these properties, at block 2953 the application defines a third volume, which is the largest viable volume that can be filled with full-sized voxels of the shape and size of the baseline lattice. The third volume is also known as the build space. The application accounts for the shell volume that cannot be filled with full-sized voxels, as well as the chunk volume, which is the volume that can be filled with full-sized voxels. The build space may also account for voxel-packing strategies, symmetry of the structure, and centering the build volume in the overall structure. With the build space defined, at block 2960 the application performs finite element analysis to determine the stress and strain, or other physics constraint, on the build volume. At block 2970 the application also performs FEA on the overall structure and at block 2971 performs process checks that include a check on the FEA on the build volume, and to check the force-boundary viability. To pass the check, the part stress must be above a threshold, e.g., 90% to 120% of the strength of the construction material plus a safety factor and error probability measure. At block 2961 the application also checks that the voxelated FEA is within an error margin of the solid structure FEA calculation. If the structure fails the error checks, the high stress areas are identified, and the user is notified that the process has failed. From there, at block 2962 the user may examine the high stress areas to determine what caused the failure.

If the structure passes the error checks, at block 2980 the application creates a stress map of the build volume so that the AI model can calculate viable solutions. Based on the stress map, at block 2981 the build volume is divided into zones. Zones and zone volumes are set based on the magnitude of stress and strain anticipated to be applied in the zone, as well as voxelization considerations, such as the requirements of the lattice shape, cell size, and beam thickness that need to be packed in the zone. At block 2982 the application determines the worst-case loading for each individual voxel and determines whether the voxel configuration can bear the worst-case loading. In some cases, a single voxel shape and cell size will be populated uniformly throughout the zone. In other cases, the zone may be sub-divided and populated with different voxels in each sub-zone. The application repeats the process for each zone.

With the zones populated with the baseline lattice, at block 2983 the application repeats the process with different lattice shapes (BCC, FCC, fluorite), cell sizes, and minimum beam thickness that will support the force loading, construction material, and printer device. Each combination of lattice is processed by the application in parallel or in series. Once the various lattice builds are calculated, the application presents the user with viable and manufacturable candidate designs at block 2990. The viable designs are ranked according to suitable criteria, e.g., printability, cost, simplicity, level of shape characterization. When presented with the candidate designs, the user may select a design for display, and the application generates a visualization that is displayed on the GUI. If desired, the user may instruct the application to provide additional explanatory information. For example, the application may translate the resultant volume mesh force back into surface forces and boundaries within which the forces are exerted. These surface force vectors are displayed on the GUI and oriented on the candidate design. Once satisfied, the user may select a candidate design for export at which point the application generates an .STL file for printing. The user may select any generated design regardless of whether it is displayed or ranked by the application. The application then sends the .STL file to a slicer program that convers the file into a g-code file, which then may be printed on a 3-D printer.

### SPECIALIZED COMPUTER SYSTEM

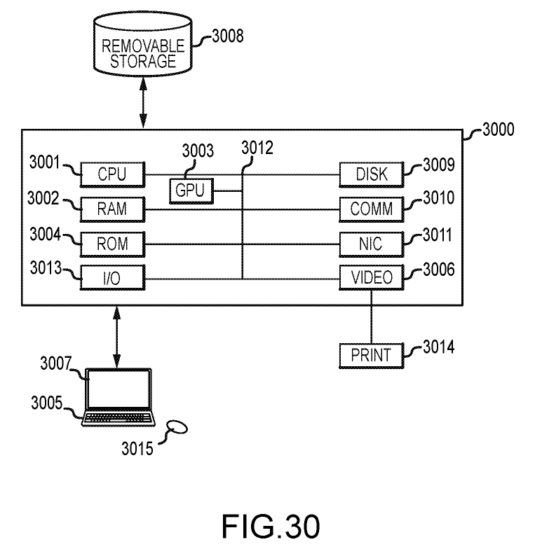

Portions of the disclosed invention may be implemented, at least in part, on a specialized computer system. FIG. 30 is a block diagram of a special-purpose computer system in which software-implemented processes of the disclosed invention may be embodied. As shown, the system 3000 comprises one or more central processing unit(s) (CPU) or processor(s) 3001 coupled to a random-access memory (RAM) 3002, a read-only memory (ROM) 3003, a fixed storage device 3009 (e.g., hard disk, flash drive), a communication (COMM) port(s) or interface(s) 3010, a high-speed network interface card (NIC) 3011, and a programmable logic card 3006. The system can be accessed by a network-connected computing device, such as a desktop, laptop, or tablet computer 3005, having a combined user interface and display device 3007 (e.g., touchscreen), or in some embodiments may be accessed through a software interface, e.g., a web-based software application for providing 3-D structural design and printing. Although not shown separately, a real time system clock is included with the system, in a conventional manner.

The CPU 3001 comprises a suitable processor for implementing the disclosed invention. The CPU 3001 communicates with other components of the system via a bi-directional system bus or network on a chip module 3012, and any necessary input/output (I/O) controller 3013 circuitry and other “glue” logic. The bus, which includes address lines for addressing system memory, provides data transfer between and among the various components. RAM 3002 serves as the working memory for the CPU 3001. ROM 3004 contains the basic I/O system code (BIOS), which is a set of low-level routines in ROM that application programs and the operating systems can use to interact with the hardware, including reading characters from the keyboard, etc. Some embodiments include a graphics processing unit (GPU) (not shown) to add processing capability to the system.

Mass storage devices 3009 provide persistent storage on fixed and removable media, such as magnetic, optical, or magnetic-optical storage systems, flash memory, or any other available mass storage technology. The mass storage may be shared on a network, e.g., cloud storage, or it may be a dedicated mass storage device. Fixed storage 3009 stores a body of program instructions and data for directing operation of the computer system, including an operating system, user application programs, driver, and other support files, as well as other data files of all sorts. Typically, the fixed storage 3009 serves as the main memory for the system.

In operation, program logic (including that which implements methodology of the disclosed invention described herein) is loaded from fixed storage 3009 into the main (RAM) memory 3002, for execution by the CPU 3001. During operation of the program logic, the system 3000 accepts user input from another computing device, keyboard, mouse, touchscreen, etc. The user interface 3007 permits selection of application programs, entry of software application or keyboard-based input or data, and selection and manipulation of individual data objects represented by a software application or displayed on the display device 3007. Likewise, the pointing device 3015, such as a mouse, or a digit in the case of a touch screen, permits selection and manipulation of objects on the display device. In this manner, these input devices support automatic or manual user input for any process running on the system. In some embodiments, the computer system 3000 displays text and/or graphic images and other data on the display device 3007. A programmable logic module 3006 provides a flexible logic resource for performing certain specialized complex functions.

The system itself communicates with other devices (e.g., other computing devices, or servers) via a port on the NIC 3011 that is connected to a network (e.g., cellular, WIFI, SATCOM, or Ethernet). The system may also communicate with local occasionally connected devices (e.g., serial cable-linked devices) via the COMM interface 3010, which may include a serial port, a Universal Serial Bus (USB) interface, or the like. The computing device operates with additive manufacturing devices, such as, fused deposition modeling (FDM), selective laser melting (SLM), or directed energy deposition (DED) machines, digital light processing (DLP) printers, stereo lithography (SLA), or other suitable manufacturing equipment that communicates with the computing device through a network, or via a near field communication protocol, such as Bluetooth.

The system may be implemented through various networks and their associated communication devices. Such networks may include servers, modems, or computers, such as a gateway computer or application server which may have access to a cloud computing system. A gateway computer serves as a point of entry into each network and may be coupled to another network by means of a communications link. The gateway may also be directly or indirectly coupled to one or more devices using a communications link or may be coupled to a storage device such as a data repository or database.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Wherever a component of the disclosed invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the disclosed invention is in no way limited to implementation in any specific programming language, or for any specific operating system or environment. Accordingly, the disclosure of the disclosed invention is intended to be illustrative, but not limiting, of the scope of the invention.

What is claimed is:

1. A computer implemented method for designing three-dimensional (3-D) structures, comprising:
performing a finite element analysis on a 3-D structure to identify high locations experiencing external forces having greater magnitude relative to low locations;
dividing the 3-D structure into one or more zones based on the high locations and the low locations;
selecting a voxel shape and a cell size for a lattice to fill a first zone of the one or more zones, the selecting step comprising:
accounting for an external shell shape adjacent to the first zone;
calculating, using a first AI model, an effect of a first physics constraint exerted on the first zone; and
calculating, using a second AI model, an effect of a second physics constraint exerted on the first zone;
populating the first zone with the lattice having the selected voxel shape and cell size; and
iterating the lattice by adjusting a lattice characteristic through a range to generate a plurality of candidate designs.

2. A system for designing three-dimensional (3-D) structures, the system comprising:
a computer for designing a 3-D structure, the computer comprising a processor, a memory, a user interface, and data storage, and wherein the processor, the memory, the interface, and the data storage are configured to run a software application on the computer to design the 3-D structure, wherein the application is configured to exchange information with a user via interaction with the interface, the application controlling the interface by presenting outputs on a display and reading data from the interface in relation to the outputs;
a plurality of artificial intelligence (AI) models stored within the memory including one or more physics AI models for designing candidate structures to perform relative to a physics constraint, and wherein the plurality of AI models is accessible by the application;
wherein the application, executable by the processor, is configured to perform the following:
determine a resultant external force on a structure from a set of external force vectors;
orient the structure orthogonally to the resultant force vector;
orient and build a preliminary lattice structure orthogonally to the resultant force vector;
adjust one or more characteristics of the preliminary lattice to create a plurality of candidate structures; and
present a subset of the plurality of candidate structures to the user.

3. A computer implemented method for designing a three-dimensional (3-D) structure, comprising:
establishing a minimum shell thickness of an external shell by designating a first volume that is less than an overall volume of the structure;
establishing a build volume and a first adjusted shell thickness by setting a baseline lattice shape and cell size and applying external force vectors to the external shell having the minimum shell thickness and the first volume;
populating the build volume with a baseline lattice;
performing finite element analysis on the external shell having the first adjusted shell thickness and the build volume populated with the baseline lattice to modify the first adjusted shell thickness to create a second adjusted shell thickness, wherein the second adjusted shell thickness improves a performance metric of the structure;
dividing the build volume into a plurality of lattice zones;
performing finite element analysis on the external shell having the second adjusted shell thickness and the build volume having the plurality of lattice zones to fine tune an interface between the external shell and each lattice zone of the plurality of lattice zones, wherein the second adjusted shell thickness is modified into a third adjusted shell thickness; and
adjusting the third adjusted shell thickness to account for one or more of a predicted structural defect or a post-processing requirement of the structure.

4. A computer implemented method for designing a three-dimensional (3-D) structure, comprising:
examining an interface between a first lattice element and a second lattice element, wherein the first lattice element and the second lattice element are one or more of a cell, a layer of cells, or a surface of an external shell;
determining if the interface includes a variance requiring a transition analysis, including determining if the first lattice element includes one or more of the following criteria not present in the second lattice element: a voxel shape, a cell size, a beam thickness;
conducting, if required, a transition analysis, comprising:
rendering one or more beams in two-dimensional (2-D) wire frame and mapping one or more nodes wherein two or more beams intersect;
expanding the one or more beams from the beam axis to the beam thickness for each of the one or more beams;
performing a first check of the one or more nodes to identify one or more of a void, a discontinuity;
performing a second check of the one or more nodes to determine if beam-to-beam mating supports transmission of a physics constraint;
increasing, if required, a beam thickness at the one or more nodes;
performing the first check and the second check;
adding, if required, a transition layer; and
performing the first check and the second check.

5. A computer implemented method for designing a three-dimensional (3-D) structure, comprising:
generating, by use of a first artificial intelligence (AI) model, a plurality of solutions for the structure, wherein the first AI model is trained to solve for a first physics constraint on the structure;
inputting the plurality of solutions to a second AI model trained to solve for a second physics constraint on the structure;
generating, by use of the second AI model, a subset of the plurality of solutions;
inputting the subset to a third AI model trained to solve for a third physics constraint on the structure; and
generating, by use of the third AI model, a set of candidate designs for the structure.

6. A computer implemented method for designing a three-dimensional (3-D) structure, comprising:
uploading a surface mesh file into a software application configured to design the structure;
characterizing an exterior surface mesh of the structure, comprising:
selecting a partial surface of the exterior surface mesh;
defining a set of boundaries for the partial surface; and
iteratively repeating the selecting step until the exterior surface mesh is characterized;
applying a physics constraint to the exterior surface mesh;
converting the exterior surface mesh into a homogeneous surface mesh, having fewer smaller mesh features than the exterior surface mesh;
evaluating the homogeneous surface mesh for errors;
normalizing the homogeneous surface mesh;
converting the normalized surface mesh to a volume mesh; and
evaluating the volume mesh for errors.
